(19) United States
(12) Patent Application Publication
(10) Pub. No.: US 2022/0138710 A1
(43) Pub. Date: May 5, 2022

(54) MOBILE PAYMENT SYSTEM, BILL CREATION SYSTEM, AND METHOD THEREOF

(71) Applicant: TORTE LLC, Cambridge, MA (US)

(72) Inventor: Steven Colvin, Cambridge, MA (US)

(21) Appl. No.: 17/511,188

(22) Filed: Oct. 26, 2021

Related U.S. Application Data
(60) Provisional application No. 63/107,049, filed on Oct. 29, 2020.

(51) Int. Cl. G06Q 20/10; G06Q 20/22; G06Q 20/32; G06Q 50/12

(52) U.S. Cl. CPC G06Q 20/102; G06Q 50/12; G06Q 20/3267; G06Q 20/29

(57) ABSTRACT

A collaborative ordering and payment method comprising: (a) generating a bill number; (b) ordering one or more items associated with the bill number, wherein the one or more items are ordered by a plurality of users; (c) dividing the ordered items among the plurality of users and calculating an amount owed by each user; and (d) processing payment by one or more of the users to fulfill a total amount owed.

### FIELD

The present teachings generally relate to a payment system, and more particularly, a collaborative mobile ordering and payment system.

### BACKGROUND

Online and mobile ordering for restaurants and other retail business has become more prevalent in recent years. As a result, many of these businesses have attempted to offer a mobile means of placing an order and/or paying for an order. For example, a customer may access a website or mobile application to select one or more entries from a desired restaurant. The customer may then place an order with the restaurant without needing to even enter the restaurant or speak in person to a server. Similarly, restaurants have begun providing mobile ordering options within their facility. For example, a restaurant may offer touch-screen devices for placing their order which is then transmitted to the restaurant for processing. Additionally, tables may include a table number to associate with each order to ensure servers bring orders to the correct customer.

However, the conventional online and mobile ordering platforms may often lack the ability to process orders by larger groups. While a plurality of customers may place a single order together, the online and mobile ordering platforms may often fail to provide a means of adequately splitting a bill for payment. Similarly, the online and mobile ordering platforms may also require all individuals to order together at the same time and pay using a single payment method. As a result, the group of individuals may be required to manually split their bill and pay each other using additional payment tools, such as cash or online payment transfer applications.

Thus, there remains a need for a more robust and collaborative mobile ordering system. What is needed is a mobile ordering system that allows a group of users to individually create their orders yet transmit the orders in a compiled manner to a restaurant. Additionally, there remains a need for a mobile ordering system that allows users to split payment of a bill free of using additional payment methods. What is needed is a collaborative mobile ordering system that allows a group of users to split a bill in a variety of ways, including by item, by portion, by percentage, by fraction, by ticket, or a combination thereof. Furthermore, there remains a need for a mobile ordering system that communicates directly with a restaurant so that the restaurant may easily track each order. As such, what is needed is a mobile ordering platform in communication with a restaurant interface to provide the restaurant substantially real-time status updates of each order.

### SUMMARY

The present teachings meet one or more of the present needs by providing a collaborative ordering and payment method comprising: (a) generating a bill number; (b) ordering one or more items associated with the bill number, wherein the one or more items are ordered by a plurality of users; (c) dividing the ordered items among the plurality of users and calculating an amount owed by each user; and (d) processing payment by one or more of the users to fulfill a total amount owed.

The ordering of the one or more items by the plurality of users may be completed via a user interface. Each of the plurality of users may order the one or more items on a separate device. The user may be logged into their account within an application for the collaborative ordering and payment method. Additionally, each of the plurality of users may be required to enter payment information prior to ordering the one or more items.

The present teachings also meet one or more of the present needs by providing a collaborative ordering and payment method, wherein: the dividing of the ordered items may be completed by each user selecting one or more of the ordered items; each of the ordered items may be split into any desired number of portions, and multiples of each portion may be selected by the plurality of users; the transmission of the ordered items to the operator may be done in a compiled manner with all finalized items being transmitted together; the transmission of the ordered items to the operator may be done individually by each user transmitting their individually ordered items; a warning may be generated prior to transmission of the ordered items to indicate whether each user has finalized their individual order; the operator may close the bill number after the total amount owed is paid by the plurality of users; a balance of the total amount owed may be tracked, and a warning may be generated to indicate to each user if the balance is still due after processing of the user's payment; the operator may mark the bill as unpaid if the total amount owed is not paid in full, and at least one of the plurality of users may be charged the total amount owed along with a fee; the one or more items may be food or beverage items selectable in a user interface of a mobile device; the plurality of users may complete steps (a) through (d) via a user interface on a mobile device, and an operator may receive substantially real-time updates from the plurality of users via a user interface on a tablet in communication with the mobile device; the mobile device may be a plurality of mobile devices collaboratively transmitting data to the tablet; the dividing of the ordered items may be completed by dividing the ordered items amongst the plurality of users by who ordered each individual item; the bill number may be associated with a table number within a restaurant; a plurality of bill numbers may be associated with a single table number and the plurality of bill numbers may also be tracked individually; the operator may manually enter the ordered items into the point of sale; or a combination thereof.

Additionally, the present teachings meet one or more of the present needs by providing: a more robust and collaborative mobile ordering system; a mobile ordering system that allows a group of users to individually create their orders yet transmit the orders in a compiled manner to a restaurant; a mobile ordering system that allows users to split payment of a bill free of using additional payment methods; a collaborative mobile ordering system that allows a group of users to split a bill in a variety of ways, including by item, by portion, by percentage, by fraction, by ticket, or a combination thereof; a mobile ordering system the communicated directly with a restaurant so that the restaurant may easily track each order; a mobile ordering platform in communication with a restaurant interface to provide the restaurant substantially real-time status updates of each order; or a combination thereof.

### BRIEF DESCRIPTION OF THE DRAWINGS

FIG. 1 is a perspective view of a system in accordance with the present teachings.

FIG. 2 is a perspective view of a system in accordance with the present teachings in communication with a point of sale (POS).

FIG. 3 is a main menu of a user interface.

FIG. 4 is an ordering menu of a user interface.

FIG. 5 is a filter menu for the ordering menu of the user interface.

FIG. 6 is a cart screen of a user interface illustrating a combined preview versus a by-ticket preview.

FIG. 7 is an item detail screen within the ordering menu versus an item detail screen within the cart screen of a user interface.

FIG. 8 is a waiting room screen of a user interface.

FIG. 9 is a bill review screen of a user interface.

FIG. 10 is a split by item screen of a user interface.

FIG. 11 is split by ticket screen of a user interface.

FIG. 12A is a bill split screen of a user interface.

FIG. 12B is an item split screen of a user interface.

FIG. 13 is a pay screen of a user interface.

FIG. 14 is a scan review screen of a user interface.

FIG. 15 is a split by item screen of items scanned or manually entered into the user interface.

FIG. 16 is a history screen of a user interface.

FIG. 17 is a bill review screen of a user interface.

FIG. 18 is a main menu of a restaurant user interface.

FIG. 19 is a bill screen of a restaurant user interface.

FIG. 20 is a close table screen of a restaurant user interface.

FIG. 21 is a table order screen of a restaurant user interface.

FIG. 22 is a manager portal screen of a restaurant user interface.

FIG. 23 is a process flow of the system in accordance with the present teachings.

FIG. 24 is a process flow of a finalize order operation of the system.

FIG. 25 is a process flow of a server receiving an order with the system.

FIG. 26 is an open bill menu of a user interface.

FIG. 27 is a restaurant information screen and associated restaurant details screen of a user interface.

FIG. 28 is a meals screen of a user interface.

FIG. 29 is an order screen of a user interface prior to an order being submitted.

FIG. 30 is an order screen of a user interface after an order has been submitted.

FIG. 31 is an order screen of a user interface after an order has been paused or waiting is initiated.

FIG. 32 is a process flow of a manage pending order operation of the system.

### DETAILED DESCRIPTION

The explanations and illustrations presented herein are intended to acquaint others skilled in the art with the teachings, its principles, and its practical application. Those skilled in the art may adapt and apply the teachings in its numerous forms, as may be best suited to the requirements of a particular use. Accordingly, the specific embodiments of the present teachings as set forth are not intended as being exhaustive or limiting of the teachings. The scope of the teachings should, therefore, be determined not with reference to the description herein, but should instead be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

The system and methods of the present disclosure may be used by one or more users (e.g., customers), business (e.g., restaurants, retail establishments, service providers, etc.), business operators (e.g., restaurant servers, managers, employees, etc.), the like, or a combination thereof. The system and methods of the present disclosure provide for a unique and unconventional means of collaboratively ordering one or more items, paying for one or more items, or a combination thereof, either when physically located in a business establishment or remotely (e.g., from home). The system and methods of the present disclosure may uniquely and unconventionally provide users the ability to customize payment methods for any bill. For example, a plurality of users may collaboratively select portions or fractions of a bill to pay for. Once selections have been made by each user, the users may directly pay the business establishment (e.g., the restaurant) without ever needing to discuss payment with the staff of the business establishment, amongst each user, or both, thereby advantageously streamlining the payment process.

The present teachings may generally relate to a system for ordering one or more items from a business establishment, providing a means of payment for the ordered items, or both. Additionally, the system may provide a means of communication between customers and business operators to provide status updates regarding orders, payments, other metrics, or a combination thereof. The system may allow for one or more computing devices (e.g., a user's mobile device or computer, a tablet provided by the restaurant, etc.) to interact with an application. The application may receive one or more user inputs from the user, such as food or drink items ordered in a restaurant. Additionally, the system may include one or more applications, user interfaces, sensing devices, computing devices, processors, servers, storage device mediums, databases, algorithms, processes, methods, the like, or a combination thereof.

The system may include one or more applications. The application (i.e., “computer program”) may function to execute the method of the present disclosure. The application may be stored on one or more memory storage devices. The application may comprise one or more computer-executable instructions, algorithms, rules, processes, methods, user interfaces, menus, databases, the like, or any combination thereof. The computer-executable instructions, when executed by a computing device may cause the computing device to perform one or more methods described herein. The application may be downloaded, accessible without downloading, or both. The application may be downloadable onto one or more computing devices. The application may be downloadable from an application store (i.e., “app store”). An application store may include, but is not limited to, Apple App Store, Google Play, Amazon Appstore, or any combination thereof. The applicable may be accessible without downloading onto one or more computing devices. The application may be accessible via one or more web browsers. The application may be accessible as a website. The application may interact and/or communication through one or more interaction interfaces. The application may be utilized by one or more computing devices. The application may be utilized on one or more computing devices. The application may also be referred to as a dedicated application.

The dedicated application may work in conjunction with one or more other applications. Other applications may allow for data of a user, related to a user, or both to be collected by the application. Other applications may also allow for data collection and/or data access from a business (e.g., restaurant) of the system, such as by collecting data regarding the business, staff of the business, customers of the business, or a combination thereof. One or more other applications may include one or more fitness and health applications, photograph applications, navigation applications, payment application, loyalty/reward applications, reservation applications, social medial application, the like, or a combination thereof. Exemplary fitness and health applications may include Fitbit®, MyFitnessPal®, Runkeeper®, Health App by Apple®, Ava®, the like, or any combination thereof. Photograph applications may include a camera application, photo album application, scanning application, the like, or a combination thereof. Navigation applications may include Google Maps®, Maps by Apple®, Waze®, the like, or a combination thereof. Payment applications may include PayPal®, Venmo®, QuickPay by Zelle® via one or more banking applications, a point of sale application, the like, or a combination thereof. For example, the dedicated application may obtain credit card information from an external bank application or may allow users to pay each other view another payment application.

One or more computing devices may include one or more user interfaces. The one or more user interfaces may function to display information related to a user, receive user inputs related to a user, display data and/or one or more prompts to a user, or any combination thereof. The one or more user interfaces may function to receive an order from a user, allow a user to pay for one or more orders items, display a menu of selectable items and/or options, or a combination thereof. The one or more user interfaces may function to modify or review an order from a customer, view the status of one or more customer orders, review metrics of a business, or a combination thereof. Thus, it may be gleaned from the present teachings that the one or more user interfaces may include interfaces for both one or more customer-based users and one or more business-based users. 55.

The one or more user interfaces may display notifications and/or advertisements to the user. Notifications may include welcome displays, walkthroughs, notices of discounts, notices of invites to interact with other users on the platform, similar pop-up information, the like, or a combination thereof. The one or more user interfaces may be suitable for receiving data from a user. The one or more user interfaces may include one or more graphic user interfaces (GUI), audio interfaces, image interfaces, the like, or any combination thereof. One or more graphic user interfaces may function to display visual data to a user, receive one or more inputs from the user, or both. The one or more graphic interfaces may include one or more screens. The one or more screens may be a screen located on a computing device. The one or more screens may be a screen on a mobile computing device, non-mobile computing device, or both. The one or more graphic interfaces may include and/or be in communication with one or more user input devices, audio interfaces, image interfaces, the like, or any combination thereof. The one or more user input devices may allow for receiving one or more inputs from a user. The one or more input devices may include one or more buttons, wheels, keyboards, switches, mice, joysticks, touch pads (i.e., a touch-sensitive area, provided as a separate peripheral or integrated into a computing device, that does not display visual output), touch-sensitive monitor screens, microphones, the like, or any combination thereof. The one or more input devices may be integrated with a graphic user interface. An audio interface may function to project sound to a user and/or receive sound from a user. The audio interface may include audio circuitry, one or more speakers, one or more microphones, the like, or any combination thereof. An image interface may function to capture, receive, display, and/or transmit one or more images. An image interface may include one or more cameras. A user interface may function to display and/or navigate through one or more menus of the application.

A user interface may display one or more menus. The one or more menus may function to arrange related user inputs on a single user interface, prompt a user through inputting one or more instruction signals and/or data signals, guide the user in navigating the application, or any combination thereof. The one or more menus may include one or more account creation menus, log-in menus, ordering menus, payment menus, history menus, filter menus, performance metric menus, item display, bill display, order display, the like, or a combination thereof. Data entered by a user in one or more menus may be transmitted to one or more databases; may be converted from one or more data signals to data entries; may be processed in one or more methods, processes, and/or algorithms; or nay combination thereof. Data entered by a user may be transmitted into one or more dynamic digital profiles of the user, of the event, or both. Data entered by a user may be associated with one or more records associated with the user, a user identification key, or both. One or more menus may be displayed on a single screen or may prompt the user through multiple, sequential screens; sub-screens (e.g., pop-ups); or both. One or more account creation menus may allow a user to create an account with the system. One or more account creation menus may collect data associated with a name, username, email, password, phone number, gender, age, height, weight, zip code, race, ethnicity, education, income, profession, social media accounts, other demographic information, the like, or any combination thereof. The system may also automatically generate an account or identifier in lieu of an account creation menu. One or more log-in menus may collect log-in information to allow a user to log-in to their account, add data to their account, the like, or a combination thereof. One or more log-in menus may collect data associated with a username, password, phone number, the like, or a combination thereof. One or more ordering menus may allow for a user to select one or more selectable items, customize the one or more selectable items, order the one or more selectable items, or a combination thereof. A user may be prompted to one or more of the menus when creating an account, each time the user logs into the system, or both. For example, a user may only be prompted through the one or more account creation menus when creating an account. For example, a user may always be prompted through a main menu and/or payment menu when logged in to the application.

The system may include one or more computing devices. The one or more computing devices may function to allow a user to interact with an application; execute one or more algorithms, methods, and/or processes; receive and/or transmit one or more signals, convert one or more signals to data entries, retrieve one or more data entries from one or more storage mediums, or any combination thereof. The one or more computing devices may include and/or be in communication with one or more processors, storage mediums, servers, networks, user interfaces, other computing devices, the like, or any combination thereof. The one or more or more computing devices may communication via one or more interaction interfaces (e.g., an application programming interface (“API”)). The computing device may be one or more personal computers (e.g., laptop or desktop), mobile devices (e.g., mobile phone, tablet, smart watch, etc.), or any combination thereof. The computing device may include a diagnostic computing system that may be associated with databases and methods disclosed herein, may be in communication with one or more user computing devices, or other computing devise, or any combination thereof.

The system may include one or more processors. The one or more processors may function to analyze one or more signals and/or data from one or more sensing devices, memory storage devices, databases, user interfaces, or any combination thereof; convert one or more signals to data suitable for analysis and/or saving within a database (e.g., data conversion, data cleaning); or a combination thereof. The one or more processors may be located in one or more sensing devices, user interfaces, computing devices, the like, or any combination thereof. The one or more processors may or may not be cloud-based (e.g., remote from other portions of the system). One or more processors may include a single or a plurality of processors. One or more processors may be in communication with one or more other processors. The one or more processors may function to process data, execute one or more algorithms to analyze data, or both. Processing data may include receiving, transforming, outputting, executing, the like, or any combination thereof. One or more processors may be part of one or more hardware, software, systems, or any combination thereof. One or more hardware processors may include one or more central processing units, multi-core processors, front-end processors, the like, or any combination thereof. The one or more processors may be non-transient. The one or more processors may be referred to as one or more electronic processors. The one or more processors may convert data signals to data entries to be saved within one or more storage mediums. A data signal may be a signal associated with an input from a user interface. A data entry may be an entry stored within one or more databases. The one or more processors may access one or more algorithms, processes, and/or methods to analyze one or more data entries and/or data signals. The one or more processors may access one or more algorithms saved within one or more memory storage mediums. The one or more processors may execute one or more methods for ordering and/or paying for selectable items. The one or more processors may execute the one or more methods, processes, and/or algorithms via one or more algorithms stored within and accessible from one or more memory storage devices; data stored within and accessible from one or more databases; or both.

The system may include one or more memory storage devices (e.g., electronic memory storage device). The one or more memory storage devices may store data, databases, algorithms, processes, methods, or any combination thereof. The one or more memory storage devices may include one or more hard drives (e.g., hard drive memory), chips (e.g., Random Access Memory “RAM)”), discs, flash drives, memory cards, the like, or any combination thereof. One or more discs may include one or more floppy diskettes, hard disk drives, optical data storage media including CD ROMs, DVDs, and the like. One or more chips may include ROMs, flash RAM, EPROMs, hardwired or preprogrammed chips, nanotechnology memory, or the like. The one or more memory storage devices may include one or more cloud-based storage devices. The data stored within one or more memory storage devices may be compressed, encrypted, or both. The data stored within one or more memory storage devices may comply with payment security regulations. The one or more memory storage devices may be located within one or more sensing devices, computing devices, one or more processors, one or more user interfaces, or any combination thereof. One or more memory storage devices may be referred to as one or more electronic memory storage devices. One or more memory storage devices may be non-transient. One or more memory storage mediums may store one or more data entries in a native format, foreign format, or both. One or more memory storage mediums may store data entries as objects, files, blocks, or a combination thereof. The one or more memory storage mediums may include one or more algorithms, methods, algorithms, rules, databases, data entries, the like, or any combination therefore stored therein. The one or more memory storage mediums may store data in the form of one or more databases.

One or more computing devices may include one or more databases. The one or more databases may function to receive, store, and/or allow for retrieval of one or more data entries. The data entries may be values associated with one or more detected signals; results from one or more algorithms, processes, rules, and/or methods; or any combination thereof. The one or more databases may be located within one or more memory storage devices. The one or more databases may include any type of database able to store digital information. The digital information may be stored within one or more databases in any suitable form using any suitable database management system (DBMS). Exemplary storage forms include relational databases (e.g., SQL database, row-oriented, column-oriented), non-relational databases (e.g., NoSQL database), correlation databases, ordered/unordered flat files, structured files, the like, or any combination thereof. The one or more databases may store one or more classifications of data models. The one or more classifications may include column (e.g., wide column), document, key-value (e.g., key-value cache, key-value store), object, graph, multi-model, or any combination thereof. One or more databases may be located within or be part of hardware, software, or both. One or more databases may be stored on a same or different hardware and/or software as one or more other databases. One or more databases may be located in a same or different non-transient storage medium as one or more other databases. The one or more databases may be accessible by one or more processors to retrieve data entries for analysis via one or more algorithms, methods, rules, processes, or any combination thereof. The one or more databases may include a single database or a plurality of databases. One database may be in communication with one or more other databases. One or more other databases may be part of or separate from the system. One or more databases separate from the system may include one or more public datasets (e.g., Centers for Disease Control and Prevention (“CDC”), Agency for Healthcare Research and Quality (“AHRQ”)) , corporate datasets and/or private datasets (e.g., data sets from larger companies provided for the greater good, such as Twitter®, Apple®, and Google®), academic datasets (e.g., data sets from universities, research networks, peer-reviewed research, literature on new and known conditions, etc.), government and/or public body data sets (e.g., World Health Organization (“WHO”)), the like, or a combination thereof. One or more databases may include a global database. One or more databases may be connected to one or more other databases via one or more networks. For example, a database of the system may be in communication with one or more other databases via the Internet. The database may also receive one or more outputs of the system. The database may be able to have the data outputted, sorted, filtered, analyzed, the like, or any combination thereof. For example, user data within the database may be able to be analyzed to determine one or more trends, deviations, variability, conditions, the like, or any combination thereof. As another example, population data for the entire or a portion of the dataset within a database may be analyzed to determine one or more trends, deviations, variability, conditions, the like, or any combination thereof. The one or more databases may include one or more user accounts, condition locations, threshold indexes, tested models, model toolbox, digital profiles, the like, or any combination thereof. The database may be suitable for storing a plurality of records.

One or more databases may include one or more records. The one or more records may function to store one or more data entries associated with one or more users. A record may include one or more data entries associated with one or more signals. The one or more signals may be collected via a user interface during a single visit or a plurality of visits to the application. The visit may be by the user, a business operator, or both. A user, a business operator, a business as a whole, or a combination thereof may be associated with a user identification key. One or more records in one or more databases may be filtered by a user identification key to execute one or more algorithms, processes, rules, or any combination thereof related to the user. For example, one or more digital profile databases may store records associate with multiple users over multiple visits to a business establishment. The one or more records may be filtered by business (e.g., restaurant) identification key, business operator (e.g., restaurant server) identification key, user (e.g., customer) identification key, bill identification key, or a combination thereof. One or more algorithms, methods, and/or processes may filter the data for a specific user by a user identification key to provide for recommendations on future orders. One or more records may include one or more data entries associated with identification data, log-in information, order history, payment preferences, food allergies, social networks, the like, or a combination thereof.

The system of the present disclosure may be integrated and/or include one or more networks. The computing devices may be in selective communication with one or more networks. The one or more networks may be formed by placing two or more computing devices in communication with one another. One or more networks may include one or more communication hubs, communication modules, computing devices, processors, databases, servers, memory storage devices, sensing devices, the like, or any combination thereof. One or more networks may be free of and/or include one or more communication hubs (e.g., router, wireless router). One or more computing devices of the system may be directly connected to one another without the use of a communication hub. One or more networks may be connected to one or more other networks. One or more networks may include one or more local area networks (“LAN”), wide area networks (“WAN”), virtual private network (“VPN”), intranet, Internet, cellular networks, the like, or any combination thereof. The network may be temporarily, semi-permanently, or permanently connected to one or more computing devices, or any combination thereof. A network may allow for one or more computing devices to be connected to the computing device to transmit one or more data signals to the one or more computing devices, receive one or more data signals from the one or more computing devices, or both. The network may allow for one or more computing devices to receive one or more data entries from and/or transmit one or more data entries to one or more storage media. The network may allow for transmission of one or more signals, status signals, data entries, instruction signals, or any combination thereof, for processing by one or more processors. It should be noted that the network may include one or more networks within a business establishment, one or more networks extending beyond the business establishment (e.g., cellular networks) or a combination thereof to ensure communication between users (i.e., customers) and the business establishment.

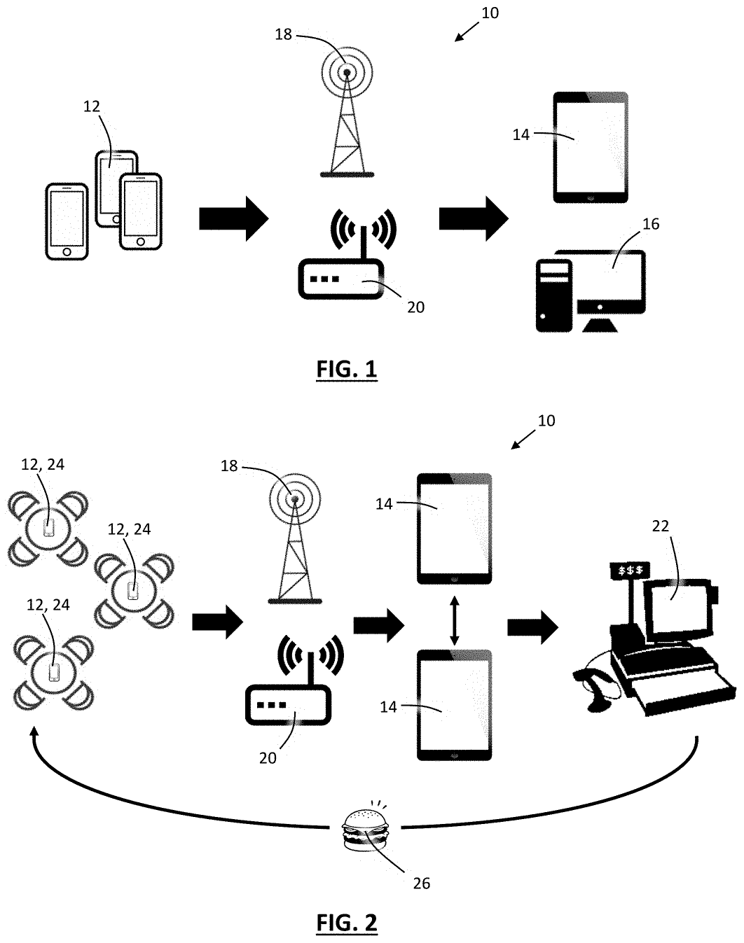

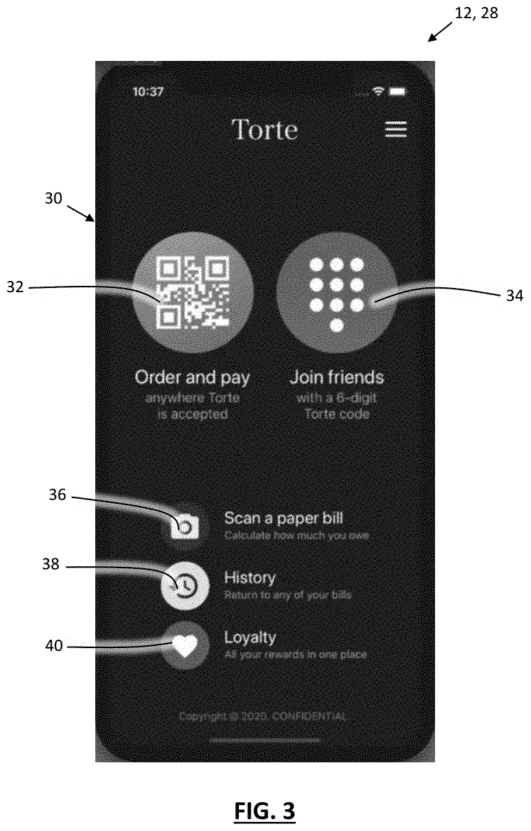

Turning now to the figures, FIG. 1 illustrates a perspective view of a system 10 in accordance with the present teachings. The system 10 may be configured to establish one-way communication between one or more mobile phones 12 and a computer 16, tablet 14, or both. It is envisioned that the mobile phones 12 may provide a user interface for customers to view one or more menus associated with a business (e.g., a restaurant food and beverage menu), enter orders, pay a bill, or a combination thereof (see, e.g., FIGS. 3-17). Once a table has been started, an order has been entered, a bill has been paid, or a combination thereof, such data entry may be transmitted to a retailer's electronic device, such as the computer 16 and/or the tablet 14. Beneficially, the system 10 may provide for collaboration between a plurality of mobile phones 12 such that a combination of orders or data entries from the plurality of mobile phones 12 may be compiled in a comprehensive manner when transmitting such data to the retailer's tablet 14 or computer 16. For example, a group of individuals may combine their meal orders in a restaurant via the user interface on their mobile phones 12. Once their orders have been entered, the system 10 may combine the orders—while still recording which individual ordered which item—and transmit the combined order to a restaurant server's tablet 14. It should be noted that transmission from the mobile phones 12 of a customer to the server's tablet 14 and/or computer may be done over a local network (e.g., a wireless internet connection, Bluetooth connection, Airdrop connection, the like, or a combination thereof in a restaurant), over a cellular network 18, or both.

While FIG. 1 illustrates one-way communication between the mobile phones 12 and a business's computer 16 and/or tablet 14, it is envisioned that the communication may also be two-way communication. For example, once a food order is entered by a customer via their mobile phone 12 and transmitted to a server's tablet 14, the server may provide a status update on the customer's order and transmit such update back to the customer's mobile phone 12. Additionally, it should be noted that a customer interface may be accessed through one or more additional devices other than a mobile phone, such as a tablet, computer, or both. Similarly, a business may also use additional electronic devices to access a server's interface, such as a mobile phone.

FIG. 2 illustrates a perspective view of a system 10 similar to the system 10 described in FIG. 1. The system 10 illustrates one-way communication from a plurality of mobile phones 12 to a business's tablets 14. An exemplary business to illustrate the system 10 may be a restaurant or “fast-food” type establishment, but it is envisioned the system 10 may similarly be adopted for quick-service eateries, cafes, and the like. Advantageously, the system 10 may include a user interface for each customer's mobile phone 12 such that each customer can place an order via their mobile phone 12 without needing to leave their table 24, speak directly to a server, or both. Each table 24 may also beneficially be able to compile orders from a plurality of mobile phones 12 prior to transmitting a table order to the tablet 14. Thus, as described herein, each customer may be able to collaboratively place an order via the system 10 while also identifying which table 24 within the restaurant the customer is seated. Furthermore, the system 10 may provide a means to not only identify a specific table 24, but also identify a specific seat at said table 24 or a customer-provided name or pseudonym to even further categorize, track, and deliver each customer's order.

The mobile phones 12 may transmit their order via a local network 20 or a cellular network 18 to one or more tablets 14 operated by the restaurant. The mobile phones 12 may transmit the order directly to the one or more tablets 14 operated by the restaurant, may transmit their orders through a third-party or database, or a combination thereof. As described above, the tablets 14 may also be replaced with any other electronic device that allows the restaurant to access a business user interface that compliments the customer user interface. Additionally, given the collaborative nature of the system 10, the business may have a plurality of tablets 14 that each interact with each other to maintain ordering and/or billing for each table 24. For example, each tablet 14 may be designated to a particular server within the restaurant or a particular group of tables 24. However, the tablets 14 may have two-way communication between each other, a third-party, a database, or a combination thereof to transmit data, such as order updates, to ensure the system 10 is run in unison. Thus, it is contemplated that the number of tablets 14 or other devices for a business may be scaled based upon the size of the business and customer demands.

Once an order has been placed and transmitted via the mobile phones 12, the order may be received and shown on the tablet 14 for a server to review. The server may then check the order to ensure accuracy of the order (e.g., verify all modifications within the order are acceptable, check availability of each ordered item, confirm customer age for alcoholic beverages, etc.) and process the order by manually entering the order into a point-of-sale (POS) 22 within the restaurant. Once the server has entered the order into the POS 22, the server may then enter into the tablet 14 that the order has been submitted. Additionally, the ordered items 26 may then be processed by the restaurant and brought to customer as designated by each order. As may be gleaned from the present teachings, the system 10 as taught herein may beneficially provide a customer a streamlined and substantially contactless ordering system.

Once an order has been completed, customers may also pay their bill via their mobile phone 12 user interface. As described herein, bill payment functionality of the system 10 may allow customers a collaborative means to split group bills via item, portions, fractions, tickets, percentages, or a combination thereof. Additionally, the system 10 may also beneficially allow individuals of a group without the system 10 pay using more conventional means, such as by cash or credit card, while remaining users of the system 10 may collaboratively pay. Once a bill has been paid via the mobile phone 12 user interface, the payment information may be transmitted to the tablet 14 to notify the server of a completed transaction. As such, the server may monitor each table to ensure that not only orders have been placed and fulfilled, but also that each order has been paid for.

FIGS. 3-17 illustrate a user interface 28 of a mobile phone 12. However, the user interface 28 may be compatible with any type of computing device.

FIG. 3 shows a main menu 30 of the user interface 28 for the system 10. As illustrated, a user may begin an ordering process by either selecting an order and pay process 32 or a join friends process 34. The processes may prompt users to scan a machine-readable code (QR code, barcode, etc.), manually enter a table number, initiate a wired connection, or engage in contactless communication with a local network (WiFi, Bluetooth, AirDrop, etc.), a contactless tag (RFID, NFC, etc.), or electronic device. The examples do not preclude other means of connection not described herein. The input may be retrieved both within and outside of the restaurant, for instance verbally, on signs or through devices inside the restaurant, or for instance on another device, a website, or a third-party application. The input can also be retrieved from outside the app without prompting, for instance, via another camera application on the device, another contactless recognition service of the device, wireless communication via text message, email, and the like, or a notification sent to the user within the app. The input may be accessible through a variety of platforms, such as a sign at the restaurant, on a website, through the application, verbally, or through a third-party. The input may also occur through non-obvious means, such as when a user is browsing a list of restaurants and selects a particular restaurant to start a bill or to view a menu with the option to later start a bill.

The input may include an establishment identifier, which may represent a specific restaurant, restaurant group, table, seat, section, or related aspect for the business. Alternatively, the input may include a table identifier. The table identifier may be a table number, or the table number may be an additional datum. Alternatively, the input may include a bill identifier. The bill identifier may be a bill number, or the bill number may be an additional datum. Similarly, the input may include a user identifier, the user having already started a bill or will join the bill. As such, the input may contain a combination of identifiers.

It should be noted that an entity may hold one or more identifiers, and certain identifiers may be reusable while others are of singular use or cannot be reassigned. It should be noted that use of an entity's identifiers may at times be correlated or may be different. Further, it is envisioned there may be relationships defined between entities through their identifiers and use of these identifiers may at times be correlated or may be different.

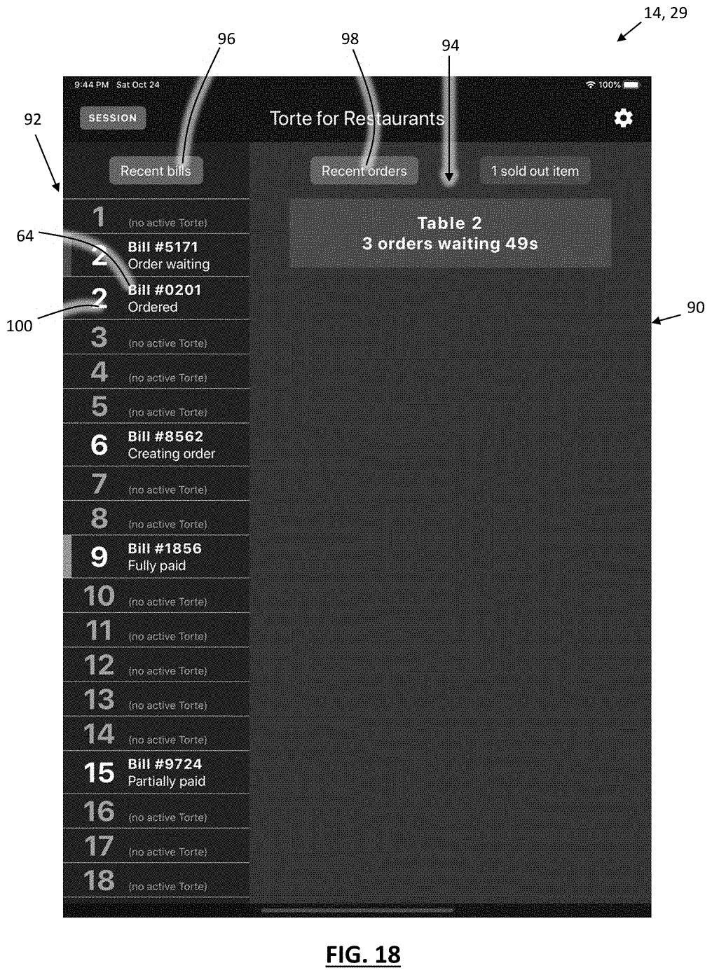

In one example, an establishment identifier may request a table identifier, which may allow a user to establish a new bill identifier or may request a user to enter an existing bill identifier. For instance, a first user may create a new bill identifier at the specific table via an order and pay process or a join friends process. A second user may then scan or input the establishment identifier, and then input identifiers for the table and/or bill. Similarly, the process can occur in reverse, whereby a bill identifier is generated prior to association to an establishment identifier. The bill identifier may be generated by the establishment as opposed to the user. The establishment identifier, table identifier, table number, bill identifier, bill number, and/or related data may be transmitted to the network separately or together for verification, storage, and/or transmittance to the restaurant. These details may help indicate to the server where each order should be delivered when received by the server's user interface (see FIGS. 18-21).

Entry into the bill may be protected by a code. The code may be generated by the restaurant, the network, a third-party, or a device already associated with the bill. The code may be short-lived and may be conveyed outside the app (e.g. email, text message, sign, or verbally by the restaurant or another user). The code may be the bill number or bill identifier itself, such as in the process described above. Certain inputs may streamline the above process, for instance by automatically generating a new bill identifier or joining an existing bill number, or by supplying or skipping the code entry.

Therefore, the system 10 beneficially allows multiple users to associate with a shared bill in a comprehensive manner to decrease confusion and congestion for the business. It should be noted that while it may be more streamlined to combine all users at a given table onto a single bill, each user may still be able to maintain a separate bill if desired, thereby indicating the same to the business for ordering and/or billing purposes, or with separate bills that are later combined for ordering and/or billing purposes.

In addition the above, the user interface 28 may also allow a user to select a scan bill process 36. The scan bill process 36 may allow the user to manually scan (i.e., take a photograph) of a physical copy of an existing bill. The system may then interpret the photograph of the bill and compile a digital version of the bill within the system 10 for the user to manipulate via the user interface 28. The scan bill process may also allow for selection of a photograph from the user's photo library, manual entry of items, or a combination thereof. Thus, the system beneficially allows users the ability to customize payment and splitting of an existing order even when a restaurant may not be fully integrated into the system 10 described herein. Furthermore, a user may then utilize the user interface 28 to accurately split an existing bill with one or more users by item, by portions, by percentage, by fraction, by ticket, or a combination thereof.

Furthermore, the main menu 30 may also allow a user to view a history screen 38 and a loyalty screen 40. The history screen 38, as described below, may provide a user a transactional history and status or summary of each order and/or payment submitted through the system 10. The loyalty screen 40 may provide a summary of loyalty rewards and benefits offered through the system 10 with associated businesses or the platform as a whole.

Moreover, the main menu 30 may provide search functionality, or may direct users to additional screens for search functionality (not shown). The search functionality may help users find other users, restaurants, or events. These users may be sorted by the user's existing network or connected through their social media accounts. The restaurants may be presented as a list or map and may be contained to a certain geographical area of the user's selection or based on the user's current location. The events may be local or geographical-set events related to food, beverage, and restaurants. Users, restaurants, and events may be engaged with, such as by following, liking, or messaging

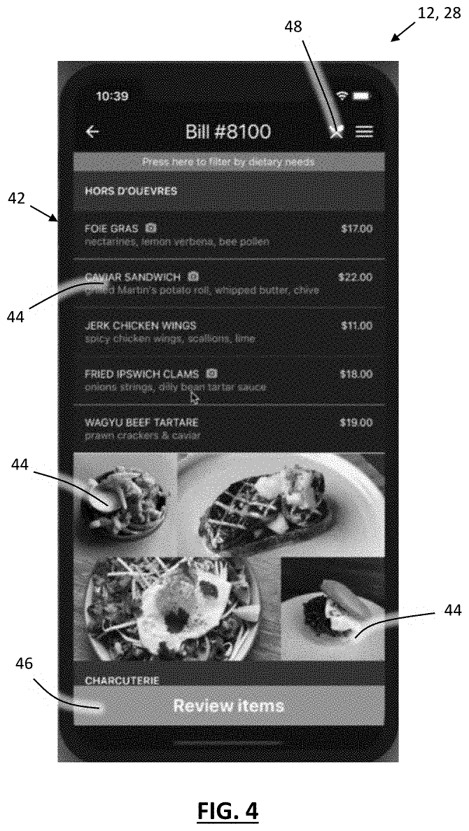

FIG. 4 illustrates a catalog menu 42 of the user interface 28. A user may access the catalog menu 42 as part of an ordering process or to review the menu for future ordering. Users at the catalog menu 42 may choose one or more selectable items 44. As shown, the selectable items 44 may contain an item name, an item price, a description, or a combination thereof, and may also beneficially be an image of a given item or other details useful to the user. Beneficially, the selectable items 44 may be grouped and arranged in any desired matter based on the requirements of a particular restaurant or business. For example, images used for selectable items 44 may be tiled in any particular manner. The images may be scaled larger or smaller to create various designs. To further aid a user in selecting one or more selectable items 44, a filter drawer 48 may be accessible from the catalog menu 42 to choose one or more filters and narrow down the selectable items 44 available. The restaurant may also employ multiple distinct menus to offer different items at different times of day (e.g., breakfast, lunch, dinner), or organize items at the same times of day (e.g., appetizers and entrees, all food and all drinks, daily specials, etc.). The restaurant may also mark one or items as out-of-stock or sold out, which may mark the item as such and prevents its selection or adding the item to the users cart, or the restaurant may mark one or more items with special promotions. Once a user has selected one or more of the selectable items 44, the user may then choose to select “review items” 46 to view a compiled list of their selections.

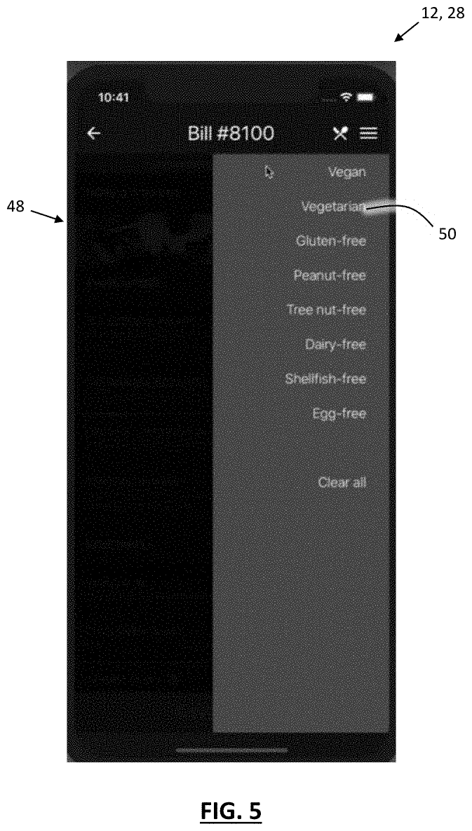

FIG. 5 shows the filter drawer 48 described above. A user may select one or more filter parameters 50 to narrow or sort selectable items 44 of the catalog menu 42. For example, a user who has one or more food allergies may select filter parameters 50 to filter out any items that are not dairy-free, shellfish-free, peanut-free, etc. As a result of the filtering, the catalog menu 42 may grey-out or otherwise hide any selectable items 44 that do not meet the filter criteria, thereby providing the user with a more comprehensive list of desired selectable items 44 to choose from. While the filter parameters 50 illustrate a variety of food allergy filters, it should be noted that the filter parameters 50 may be any desired options. For example, the filter parameters 50 may also include a type of meal (e.g., breakfast, lunch, or dinner), price range, new items, previously liked items, popularity of item, or a combination thereof.

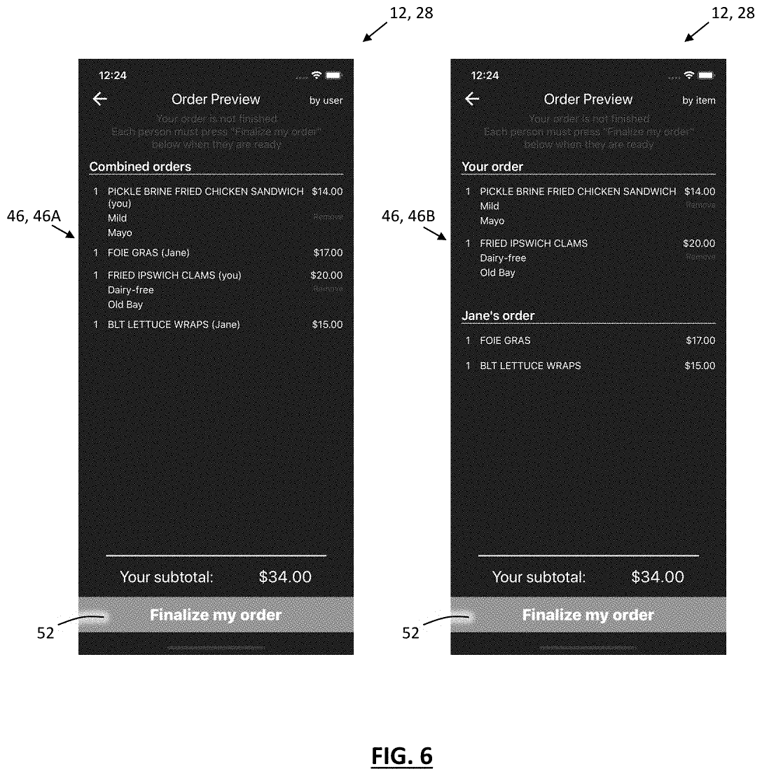

FIG. 6 shows a cart screen 46 of the customer user interface 28. The cart screen 46 may be shown to a user after selecting their desired items from the catalog menu 42 or may also be shown to a user who has not selected any desired items. Items may be presented with additional information, such as their quantity, price, selections, modifications, or a combination thereof. The cart screen 46 may beneficially allow a user to view a combined preview 46A of all compiled carts within their bill in a collaborative manner. For example, the carts may include a plurality of users each using their own mobile phone 12 to place their order on a joint bill. Once each user adds items to their cart, the combined preview 46A may allow each user to not only see their own selected items, but all selected items for their table. The cart screen may even allow users to split items before submitting their cart. Thus, the user interface 28 may beneficially provide each user a substantially real-time view of all items being placed by a group.

Similarly, the cart screen 46 may also allow users to view a table's carts categorized by ticket 46B. The items selected may be still be compiled as a group to see real-time but each user may have their own designated section to illustrated exactly which items that user specifically selected. Once a user has reviewed their cart on the cart screen 46, the user may begin to finalize their cart, create or join an order, and reach the waiting room screen 52.

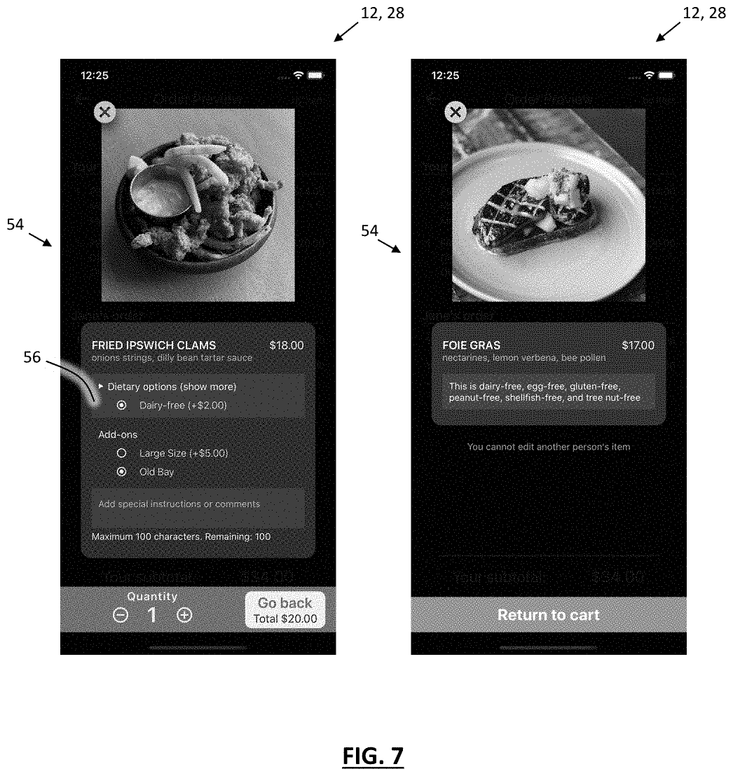

FIG. 7 illustrates item detail screens 54 for exemplary selectable items. The item detail screens 54 may be accessible by selecting one or more selectable items from the catalog menu 42 or by selecting one or more selectable items from the cart screen 46. The information shown on the item detail screen 54 may be changed depending on the previous screen or the existing inventory of that item. For example, one or more selectable options 56 may appear to further customize the user's order, such as with sizes, dietary needs, modifications, specifications, add-ons, upsells, and the like. Some customizations may already be pre-selected, for instance if the selectable option matches an active filter from the filter drawer 48, or if the selectable option matches data generated by the user and stored in the database. As another example, if a user is accessing the item detail screen 54 from the cart screen, where the item was already selected by the user in question, the selectable options 56 may be pre-selected according to the user's prior specifications. In either of these cases, the user may be allowed to alter the selectable options 56, comment, or quantity. Conversely, if a user accesses the item detail screen 54 for an item selected by another collaborative user, the item detail screen 54 may display the item and populated selectable options 56, or may only provide basic information regarding the item and no selectable options 56 such that the item and its selectable options 56, comment, or quantity may not be editable. Thus, the user interface 28 may restrict editing between collaborative users.

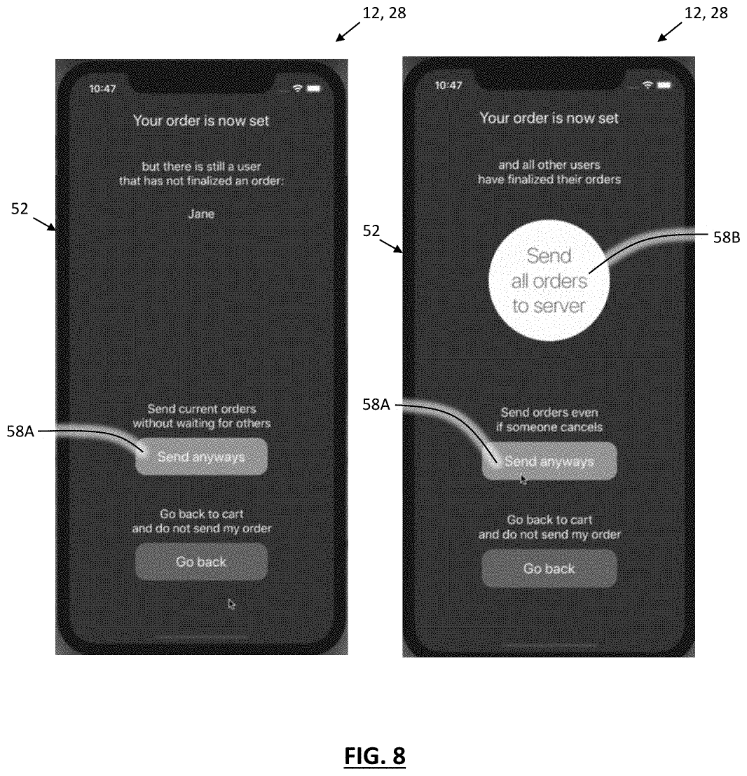

FIG. 8 illustrates a waiting room screen 52 of the user interface 28. The waiting room screen 52 may be reached after reviewing the compiled carts on the cart screen. However, the waiting room screen 52 may also be accessed in any desired way or skipped entirely for some use cases. The user interface 28 may allow for each user to send their individual cart or all currently finalized carts to the server without waiting for all users within a group to finalize their order 58A. However, the waiting room screen 52 may provide a warning to the user, indicating that not all users on the collaborative bill have created and/or finalized their order. This may beneficially alert a user to refrain from sending in their order individually and potentially causing confusion for the restaurant. Instead, the user may wait until all group carts have been finalized. Once all orders have been finalized, a “send all orders to server” option 58B may appear, thereby indicating to all collaborative users that the carts may be placed altogether. It should be noted that while all users may view a similar screen, only one collaborative user may need to select send all orders 58B for the group.

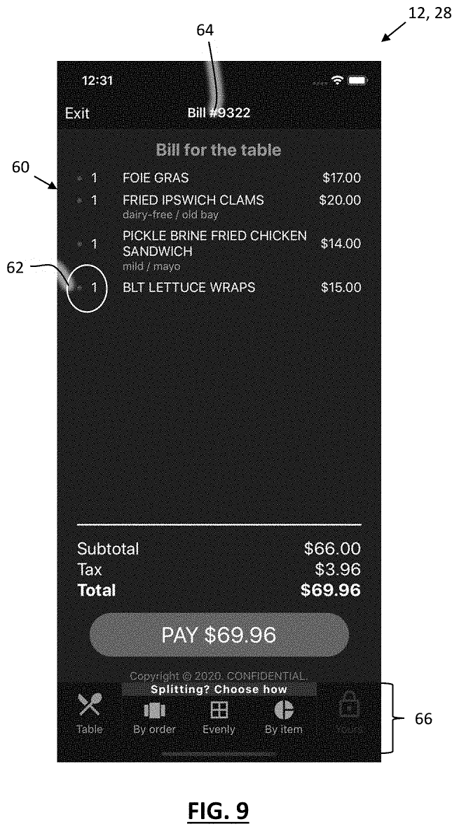

FIG. 9 illustrates a bill review screen 60 of the user interface 28. Once an order has been placed, the user may pay their bill via the bill review screen 60. In some use cases, users may be asked to complete payment before the order is sent to the server/restaurant. Payment may be allowed to occur before, during, or after the rendering of services by the business. The bill review screen 60 may contain a bill number 64, a list of items on the bill, a summary of the bill, a plurality of options to pay for the bill, a faster singular option to pay the bill, or a combination of these. The plurality of options to pay for the bill may be presented in any form, shown here as a bill split bar 66. The singular option to pay the bill may be presented in any form, shown here as a button for a single individual to pay for the entire table's order.

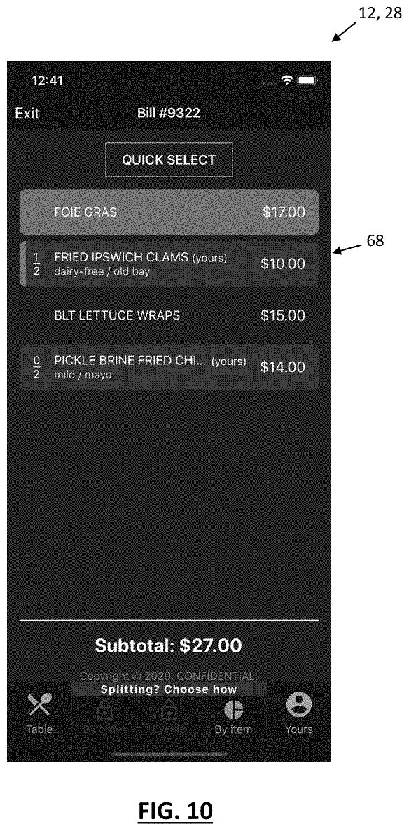

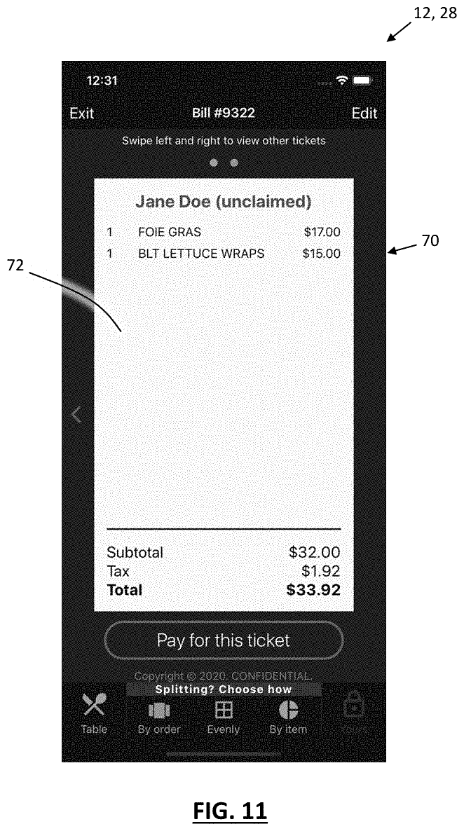

The bill split bar 66 may provide users the ability to split the bill by order (i.e., by ticket) so that each user is paying for the items they order themselves (see FIG. 11). Similarly, the bill split bar 66 may also allow users to split the bill by managing specific items from the bill to pay for (see FIG. 10), regardless of which user ordered the item. Additionally, users may also split the bill evenly (fractionally) amongst each other regardless of who ordered which items. However, it should be noted that users may split the bill in any desired way, such as by percentage, ticket, fraction, portion, item, or a combination thereof.

In addition to providing bill payment options, the bill review screen 60 may also provide an indicator 62 next to each ordered item on the bill. The indicator 62 may indicate to users the payment status of the item. For example, users may select items for which they plan to pay. Those items whose future payment is fully accounted for may have a specific color indicator (e.g., yellow) next to the item on the bill review screen 60. Similarly, if an item has not been selected by anyone yet, another color indicator (e.g., red) may be shown next to that particular item. Similarly, if an item has been split whereby at a certain moment, only a portion of the items full price is accounted for by user selection, the item may have another color indicator (e.g., purple). Once payment for an item has been processed, the indicator 62 may then further change to a different color indicator (e.g., green) to indicate to all collaborative users that the item has been paid for. It should be noted that the absence of an indicator may indicate its status for one or more states. Alternatively, text may be used to convey this information.

Similarly, if the bill is to be split by order (i.e., by ticket), a user may select one or more tickets and account for those related items for payment. The items on that selected ticket may then indicate a specific color on the bill review screen 60 to indicate to all collaborative users one or more of the above status states.

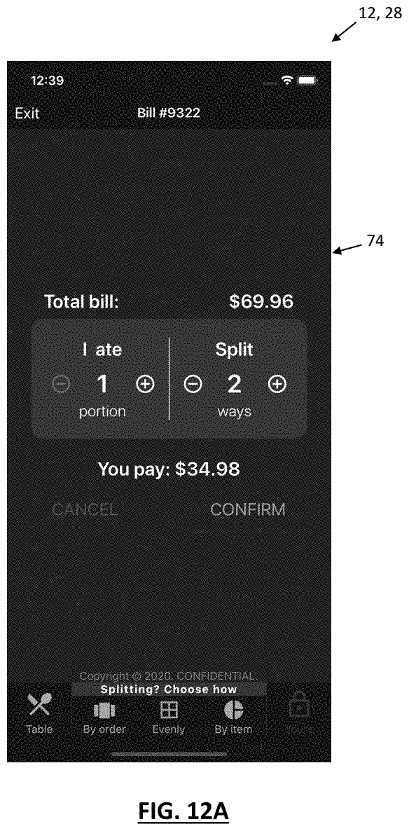

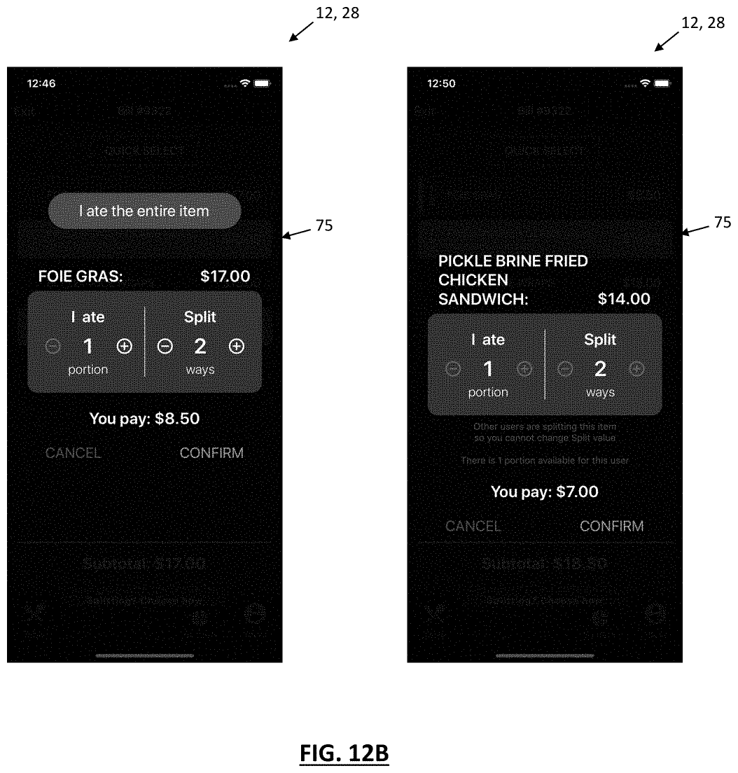

FIG. 10 is a split by item screen 68 of the user interface 28. As illustrated, a user may select specific items from the bill to pay for. The items may be selected by one or more user commands, such as swiping in a desired direction along the item, tapping on the item, entering a sub-screen of a particular item, applying a command across all available items, or a combination thereof. Items may be grouped, for instance by user orders, and entire groups may be similarly selected. Beneficially, collaborative users may also split individual items into portions to further customize payment of a bill (see FIG. 12B).

FIG. 11 is a split by ticket screen 70 of the user interface 28. As shown, a user may “claim” a particular ticket 72 associated with a user's individual order to pay for such ticket 72. The user may pay for their own ticket 72, other collaborative users' tickets 72, or any combination thereof. Users may also be requested or empowered to add or remove items or item units from these tickets. For instance, users that split an item may edit their tickets, removing a portion of that item from one ticket and transferring it to another. The system may also prevent claiming tickets and progressing payment if there are items or portions of items that are not assigned to a particular ticket. This may occur if users remove an item or portion of item from one ticket and fail to transfer it to another. Similarly, there may be instances for the application where it is difficult to assign an item to a particular ticket, for example if the item is added to the order by the server at the POS after being communicated verbally at the table. The server may have forgotten the identity of the user requesting the item, or application may prevent servers from handling user orders directly to protect user privacy. In these cases, one or more users must assign the item(s) to ticket(s) before further tickets are claimed

FIG. 12A is a bill split screen 74 of the user interface 28. When splitting a bill, a user may beneficially select to pay for only a fraction of the total bill. The bill may be split in any desired fraction of the total to further customize the bill payment process within the system. The system may then track any remaining portion of the total bill to ensure that other users are only allowed to pay the remaining portions not already accounted for. Conversely, the bill split screen 74 may be treated as a command to split each item within the bill according to the desired fractions.

FIG. 12B illustrates an item split screen 75 of the user interface 28. When splitting a bill by item, a user may select an entire item or may beneficially select to pay for only a fraction of the item. The item may be split in any desired fraction of the whole item to further customize the bill payment process within the system. The system may then track any remaining portions of a particular item to ensure that other users are only allowed to “claim” the remaining portions not already accounted for. When an item is split fractionally, the system may track any remaining portions to prevent overpayment and/or underpayment. The system may further detect if a user's portion requires their cost for the item to be rounded up or down, and may track these rounded amounts to ensure the user is not consistently charged in excess for multiple rounded items. If an item has been split or is currently being split by a second user, a first user may be unable to further split or select additional fractions of the total item to ensure each item is properly claimed.

For example, an item may be assigned a subtotal and tax value or rate (e.g., a percentage). A user may request the item is split into a desired number of portions, such as, for purposes of this example, 5 portions. The system may calculate the floor value (e.g., rounding down to the penny) of the split subtotal and tax, along with their respective remainders from the division. The system may then create 5 “units” and assign the floor values of the subtotal and tax. The remainders are also parceled out among the units so that all units are within one cent. These values may be compared to the exact (unrounded) price of ⅕ of the item, and this fraction or “overage” may be further stored with the unit. An unconventional and advantageous solution to this process may be to iterate through each unit: the unit subtotal equals the floor subtotal (plus one if the unit number is less than the subtotal remainder); the unit tax equals the floor tax (plus one if the unit number is greater than or equal to the number of portions less the tax remainder); and the unit overage is the preceding two values minus the exact expected value of: (subtotal+tax)/5.

Following this process, users may beneficially select units to create their personal bill and calculate the amount owed. The unit overages may be summed, and users with a high overage may automatically be assigned units with a low user overage, or vice versa. It should be noted that the units may be expanded for other considerations, such as discounts or surcharges. Beneficially, units may be tracked by their status, such as claimed and paid, which may help distinguish between units so users can pay multiple times on the same bill. Users may not be aware of the existence of units, as the system may only display certain relevant information like the sum subtotal and tax of units selected by the user for each item. The units may reset and/or clear if no users possess any units for an item. As such, based on the above example, it may be gleaned from the present teachings the system described herein may beneficially provide a plurality of collaborative users the ability to select and/or pay a fraction of an item, pay one or a plurality of times on the same bill, or both. Thus, the present system may provide an unconventional manner to divide and process bill payment.

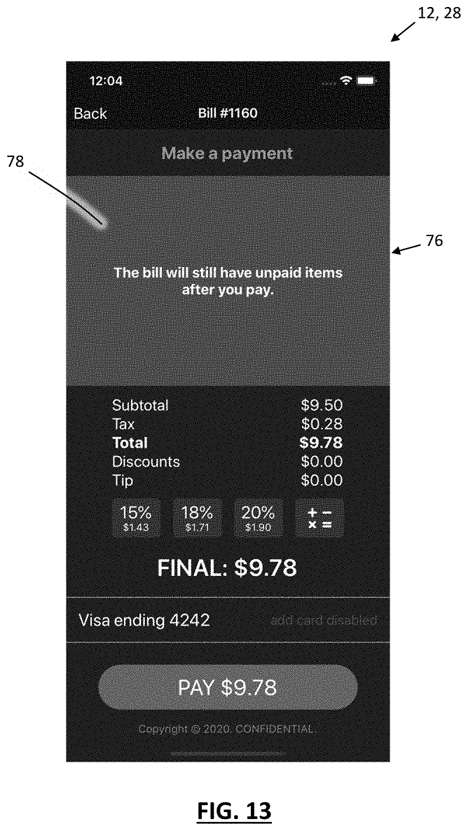

FIG. 13 is a pay screen 76 of the user interface 28. Once a user selects the items they want to pay for, the user may reach the pay screen 76 to process their payment. The pay screen 76 may allow a user to pay using a credit card on file and add a tip (if desired) to the bill. Beneficially, the pay screen 76 may also include a warning window 78 that notifies a user if the bill will have any unpaid items after payment is processed. As such, the system tracks each item on the order for payment to ensure no part of the order goes unpaid. If a collaborative user is the final user of their bill to pay for their portion, the warning window 78 may require the user to override the notice for payment if unpaid items remain on the bill (i.e., if the user were to pay and not claim the unpaid items, there would be a remaining balance owed to the business). The pay screen 76 may also allow the user to apply one or more discounts to their bill. The pay screen 76 may also collect feedback from the user regarding their dining and/or application experience, or this feedback may be collected on a subsequent screen or from follow-up communication. Additionally, it is envisioned that once a user pays an initial split portion of a bill, the user may then still have the option to pay a second time for an unpaid portion of the bill.

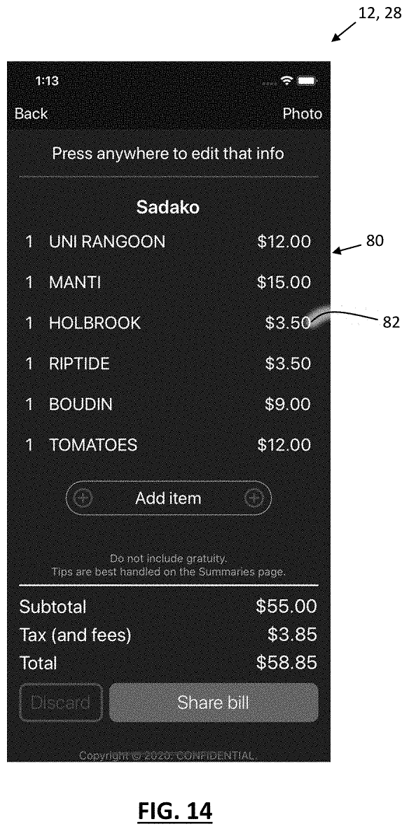

FIG. 14 is a scan review screen 80 of the user interface 28. The user interface 28 may allow a user to take a photograph of a physical bill or select a photograph from the user's photo library on their mobile device 12. The system may then detect the text on the bill and compile a list of scanned items 82 from the bill. The user may then manually edit any items within the bill, add items to the bill, delete items from the bill, or a combination thereof to compile an accurate digitized copy of the physical bill, thereby allowing the user to beneficially use the splitting payment capabilities of the system. Advantageously, the photograph process may also be skipped, thereby allowing for manual entry of items.

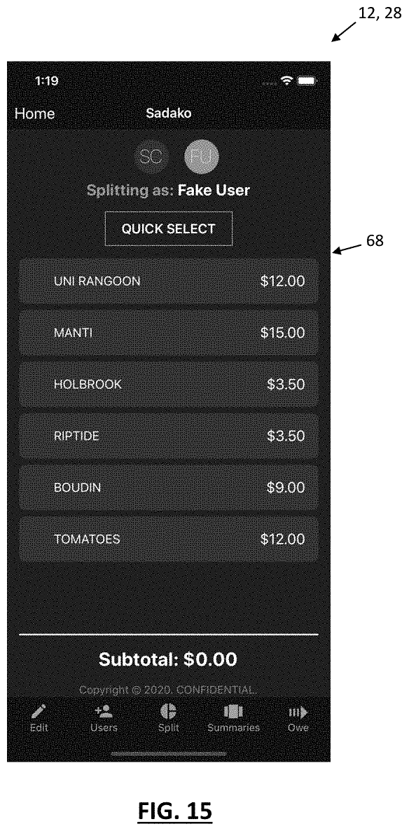

FIG. 15 is a split by item screen 68 based upon the scanned bill discussed in FIG. 14 above. Users may then split the bill by item in any desired manner similar to the splitting bill operations when placing an order through the system. Users may also join a scanned bill and split the items for themselves. In addition to a plurality of users joining a scanned bill to split the items for themselves, users may add the names of other individuals, and split on their behalf. This is useful when other individuals may not have the application or their device, yet still want to calculate their portion of the payment. The system may then calculate what each collaborative user owes on the bill. As a result, the system may also beneficially offer payment options to transfer payment between the collaborative users and connect the users with such payment options.

It should be noted that the above processes may be presented in a uniform style, or it may allow for customization for each business depending on their needs, as in “white-label” applications. Thus, it may be gleaned from the present teachings that the system and processes described herein may provide customization and flexibility based on a given business.

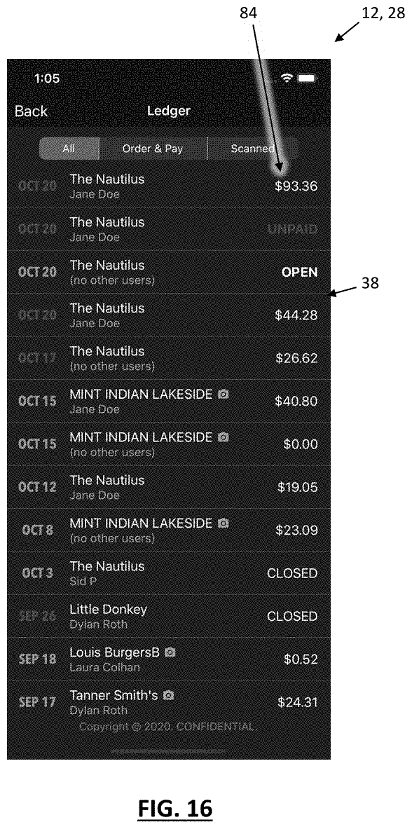

FIG. 16 is a history screen 38 of the user interface. The history screen 38 may illustrate a ledger of previous transactions. The ledger may provide a status column 84 to indicate the state of the bill and the user's interaction with the bill, for instance if the bill is open, close, unpaid, how much the user paid or should pay, or the cost of the total bill. The status column 84 may also include any further parameters desired. Color may also be employed to indicate or emphasize the state of the bill. Additionally, the history screen 38 may filter between order and pay transactions and scanned transactions. Furthermore, the history screen 38 may allow users to search or filter their previous transactions on any of a number of metrics, including the name of the restaurant, date, fellow diners, amount spent, and items orders.

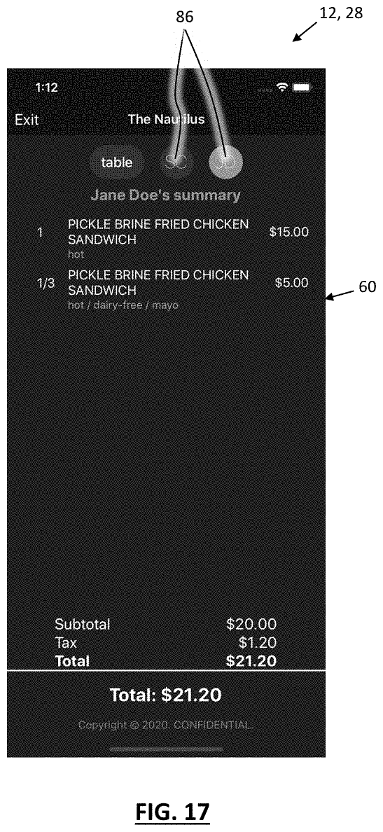

FIG. 17 is a bill review screen 60 accessed from the history screen of FIG. 16. A user may access prior transactions to see a bill review screen for the selected transaction 60. The bill review screen 60 may provide a summary of the transaction, such as items ordered and a total for the bill. Additionally, the bill may be viewed in a compiled summary or may be split be each user selection 86. Variations of the bill review screen 60 may be applicable to both order and pay transactions and scanned transactions and may also be accessible from within those individual process flows. These variations may have additional features when necessary, for instance order and pay transactions may include tip and discount values, while a scanned transaction may include a section for selecting and calculating tips for each user or the compiled summary.

FIGS. 18-22 illustrate a restaurant interface 29 of a tablet 14 for a server or business employee in a restaurant. However, the restaurant interface 29 may be compatible with any type of computing device and may be modified or adapted to fit the design of that computing device and the needs of the user on that computing device. The restaurant interface 29 illustrated in FIGS. 18-22 may provide a different interface to that of the customer user interface described in FIGS. 3-17, yet the restaurant interface 29 for the server may be in one-way or two-way communication with the user interface of the customers within the system. It is envisioned that the restaurant interface 28 could allow a business employee to perform the entire bill creation, order, and/or payment process, with customers either restricted from or opting into using the customer user interface for those processes. The restaurant interface 28 may also provide access to unique features not present in the customer user interface version, such as menu editors, data analytics, subscription purchases, and the like.

FIG. 18 is a main menu 90 of the restaurant interface 29. The main menu 90 may provide a server or other business operator a summary of pending activities for the restaurant in the system. The main menu 90 may include a bill column 92 that shows each open bill number 64 and a designated table number 100 for said bill. The table number may be combined or replaced by another signifier, such as for pickup, delivery, section number, or seat number. A status may also be shown in the bill column 92 to indicate the status for that bill (e.g., creating order, partially paid, fully paid, waiting for order, etc.). The status may also be conveyed or emphasized through color. The main menu 90 may also include a status window 94 to indicate if a table is waiting for an order and/or what duration of time has elapsed since placing their order. However, it is envisioned that the main menu 90 may be customized to show any desired information in the status window 94. The main menu 90 may also include access to a recent bills screen 96 and a recent orders screen 98. The recent bills screen 96 and the recent orders screen 98 may each show a ledger—similar to the history screen of the customer user interface—of past bills and past orders, respectively, though presenting a different set of data points useful to the restaurant and servers. These past bills and past orders may each be selectable to provide further information regarding the bills and orders.

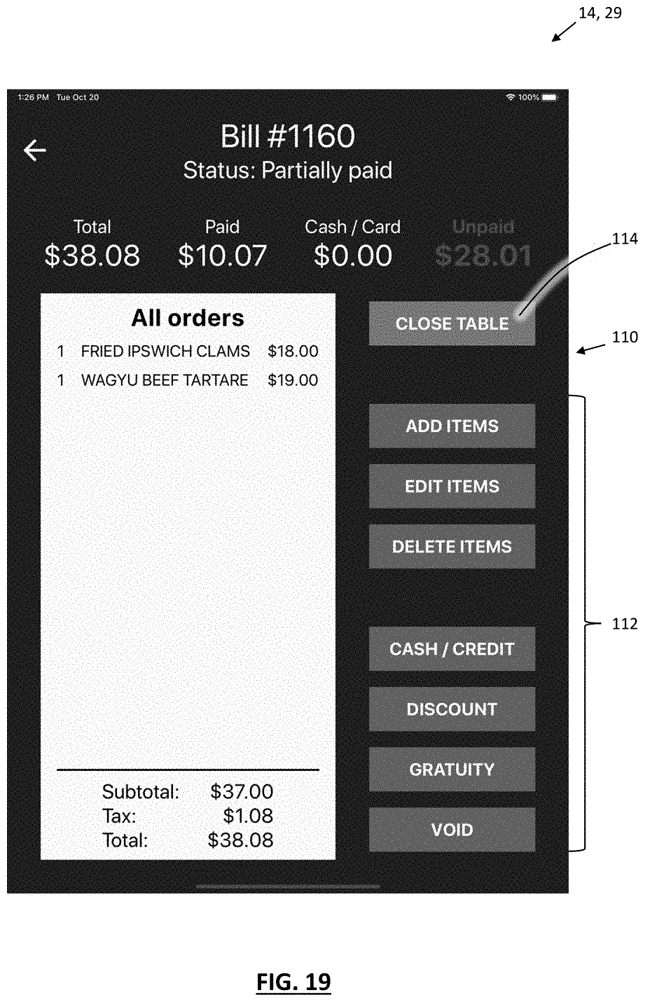

FIG. 19 is a bill screen 110 of the restaurant interface 29. The bill screen 110 may be reached by selecting an individual bill from the main menu shown above, or through any other reference to the individual bill such as on the table screen 116. The bill screen 110 may provide the server a detailed breakdown of the current order. A server or business operator may also have one or more selectable actions to modify or change the bill, such as by adding, editing, or deleting items, offering discounts or credits, voiding the transaction, other actions, or a combination thereof. Furthermore, when an order has been fulfilled by the business, a server may check the bill screen 110 to see if the bill has been paid or whether an unpaid balance still exists. When the bill has been paid in full, the server or business operator may then enter a close table screen 114 to close out the bill from the system. It should also be noted that the server may reach the close table screen 114 at any desired time to close out the bill. For example, if a customer has left without paying the bill in full, the server or business operator may close the table and indicate the bill remains unpaid. If at the end of a business day or shift the bill remains unpaid, a manager for the business may communicate through the system that the bill was unpaid, thereby indicating to the system that the customer should be charged the bill with a penalty fee. It should also be noted that the information on these screens may be modified, moved, removed, consolidated, or a combination thereof according to the needs of the restaurant. For example, one or more portions of the information on these screens may be consolidated to eliminate one or screens within the restaurant's user interface 28. It should also be noted that the marking of a bill as unpaid may still allow for users to pay for the bill before being charged by the system with the associated penalty fee.

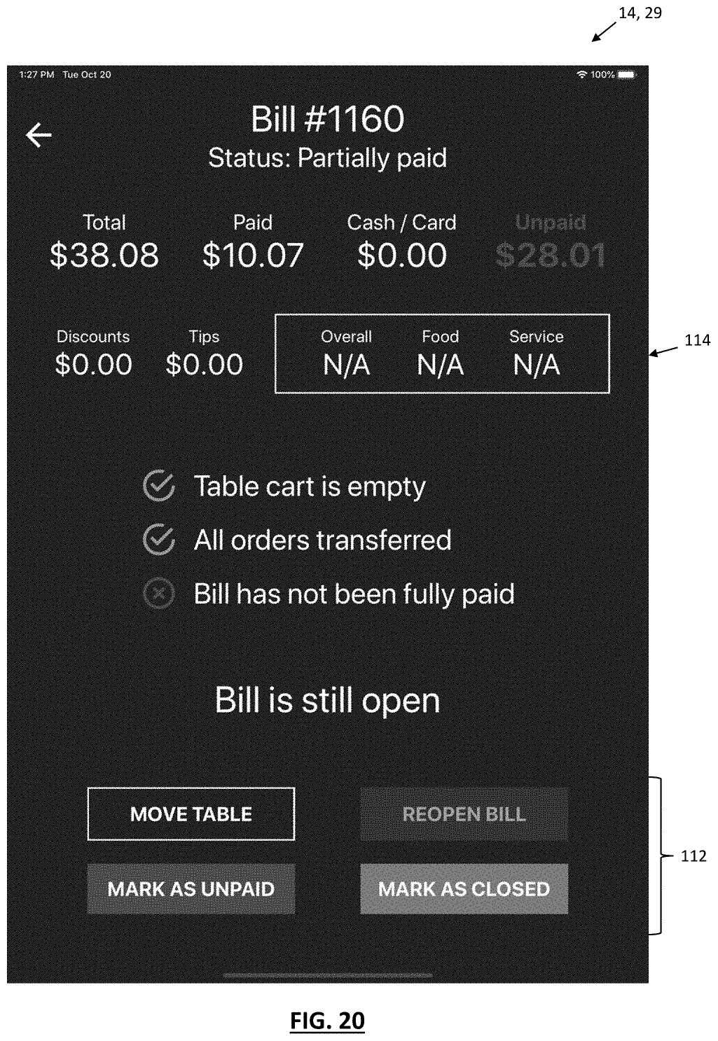

FIG. 20 illustrates the close table screen 114 accessed from the main menu 90 of the restaurant interface 29. The close table screen may provide a further detailed status update regarding a particular bill. Additionally, the close table screen 114 may include one or more selectable actions 112 to modify the bill, close the bill, or mark the bill as unpaid.

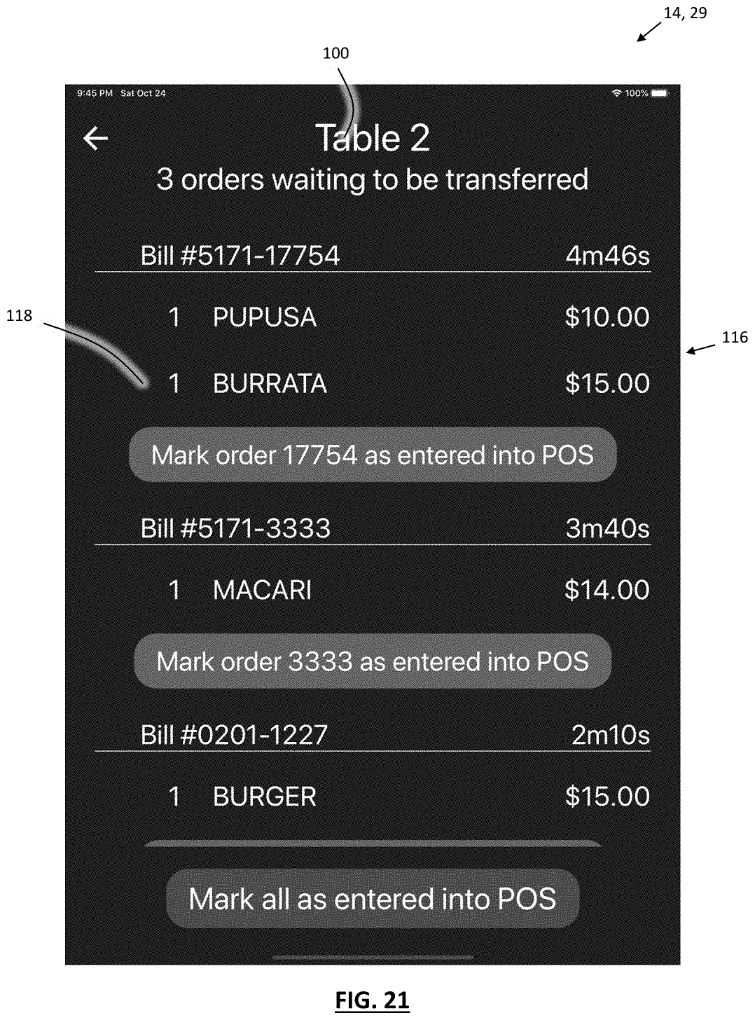

FIG. 21 is an outstanding orders screen 116 of the restaurant interface 29. Beneficially, the restaurant interface 29 may allow a server to access each individual bill (see FIG. 20) and also each individual outstanding order. As shown, a table may include a plurality of orders all collaboratively compiled under the same table number 100, even if these orders were submitted at different times or belong to a plurality of bills. Once a server receives the order placed by one or more customers on one or more bills, the server may enter each order into their POS 118.

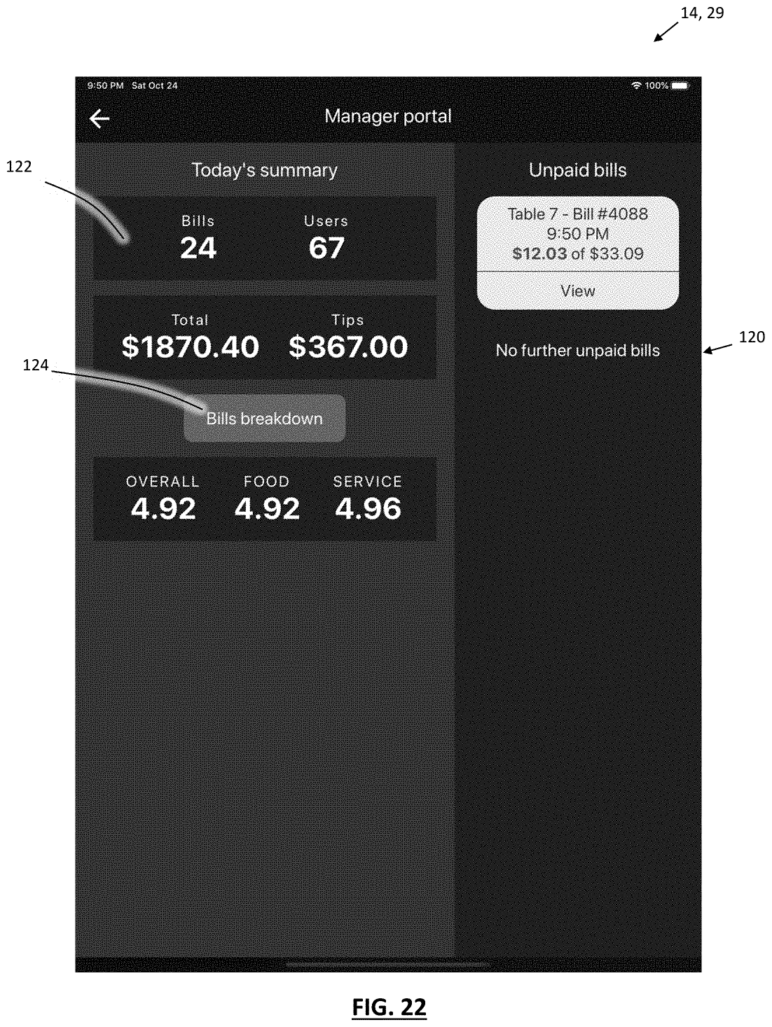

FIG. 22 is a manager portal 120 of the restaurant interface 29. The manager portal 120 may provide one or more performance metrics 122 to illustrate a summary of the business's performance. The manager may also see a bill breakdown 124 to review an overhead summary of various metrics, including the number of users, subtotals, tips, discounts, customer feedback, etc. Additionally, the manager portal 120 may also include an unpaid bills section to determine if any bills remain unpaid, as indicated by a server and described above. The unpaid bills section may provide additional information for each unpaid bill, such as bill number, table number, time, total amount, unpaid amount, other similar information, or a combination thereof.

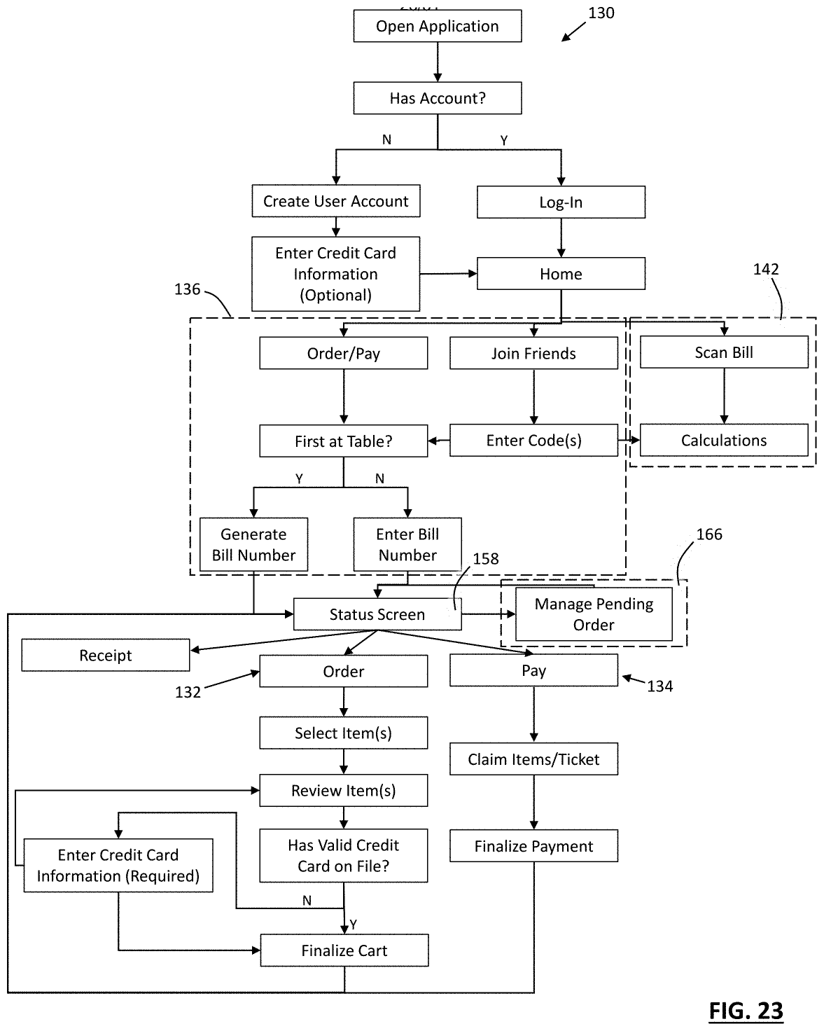

FIG. 23 illustrates an exemplary system process 130 of the system described herein. To begin, a first-time user may create a user account within the system via the customer user interface (see FIGS. 3-17), and then may be prompted to enter credit card information. However, it should be noted that an account may not be required to interact with the remainder of the system process 130.

After a user has completed the starting process, the user may select a desired option to either initiate an initiation/association process 136 or a scan/calculation process 142 as described above. In some instances, a user may have scanned, tapped, or otherwise received data, such as the establishment identifier or bill identifier, that may allow them to skip all or part of the initiation/association process 136.

Once a bill has been established, a user may be brought to a status screen 158. From the status screen 158, a user may either select an order process 132 or a pay process 134. The order process 132 may initiate an order sequence for the user to select one or more items to order. The user may also have an opportunity to review their order or other users' orders. The user may review these orders prior to finalizing their cart. The user's cart may then be compiled as a pending collaborative order. Once an order has been joined, the user may be returned to the status screen 158. The status screen 158 may permit the user to manage a pending order 166. The manage pending order process 166 may allow a user to manage orders prior to submission to the business, although it is envisioned certain addendums and alterations may be made after submission to the business. After the manage pending order process 166 has been completed, a user may then enter the pay process 134 to pay for the order. It should also be noted that once payment of the order or one or more items from an order has been finalized, a user may return to the status screen 158 to further order or enter the pay process 134 again. Moreover, from the status screen 158, a user may obtain a copy of their receipt for the order and/or payment.

It should be noted that such a status screen 158 may be used in lieu of, or in conjunction with, the cart screen 46 (FIG. 6) and/or the waiting room screen 52 (FIG. 8) discussed above. For instance, a user may send an order independently from the cart screen without the manage order process 166. Alternatively, a user may finalize their cart as part of a collaborative compiled order with their entire table from the status screen 158 (i.e., a plurality of finalized carts compiled into a collaborative order) without a waiting room screen 52. Therefore, the exemplary system process 130 does not exclude the moving, combination, removal, or enhancement of actions, screens, or functionality underlying this process.

Additionally, the user may bypass the order process 132 entirely and enter a pay process 134 to claim one or more already ordered items or tickets and finalize payment on such items. For example, if a user is joining a group of collaborative users after a table's order has been placed, the user may pay a portion of the bill even though they did not order themselves. Alternatively, the business may provide an input method such as one or more bill numbers, QR codes, RFID tags, etc., that allows users to pay without ordering through the system.

The exemplary system process may be enhanced by a series or notifications or alerts based on certain actions, events, or statuses related to a bill or their account. These notifications may be present within the application or through the device's native notification platform, and may require input from the user.

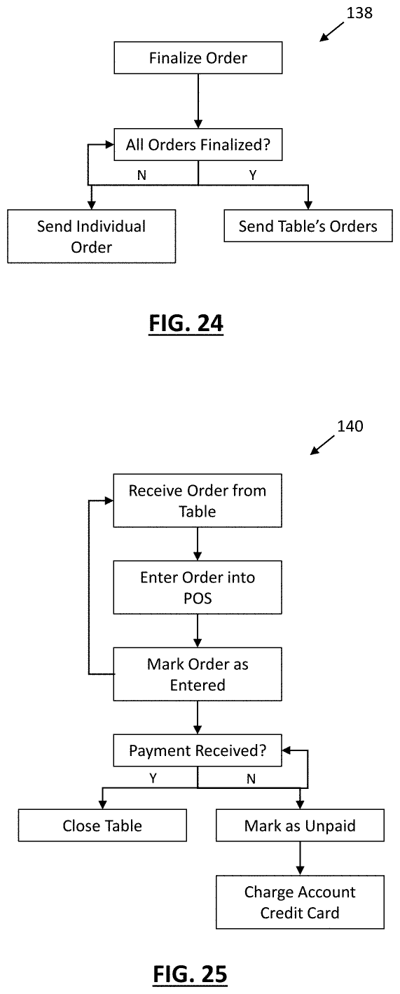

FIG. 24 is a process flow of the finalize order process 138 of FIG. 23 in further detail. The finalize order process 138 may first check to determine if all orders within a collaborative group have been finalized by each user. If one or more other users have not started or finalized their order, the users may send their orders ahead of the remaining users or may wait until every other collaborative user has finalized their order. The system may continuously track each user's finalization to provide a substantially real-time update to each user. Once each collaborative user finalizes their order, an option may appear for the users to send the entire table's orders together, thereby compiling each individual's items.

FIG. 25 is a process flow of an order entry process 140 for a server or business operator. Once an order is received from one or more users as described in FIGS. 23 and 24, a server may review the order via their user interface. After review, the user may enter the order into their point of sale (POS) for processing of the order. However, it is also envisioned that the system may be integrated into the POS, or that the system may function as a full-service POS with ticket printing and/or kitchen display, thereby eliminating a need for manually entering an order into a separate POS. Once the order has been entered, the server may mark the order as entered in their user interface and continue to address other orders that may have been placed by the table. The user interface 28 may allow the server to provide additional updates on the progress of the order.

As described above, the user interface 28 may permit the server to monitor the bill, monitor the table, check payment status, or a combination thereof. If full payment has been received, the server may close the table and log the transaction, or the table may be closed automatically by the system. If full payment has not been received, the server may continue to check updates within the system until payment has been received. Alternatively, the server may monitor a pickup or delivery status of the order. Similarly, if a server has determined that payment will not be received and they should not continue to wait for updates, the server may mark the bill as unpaid, which may then be confirmed by a manager and eventually charged to a user's credit card.

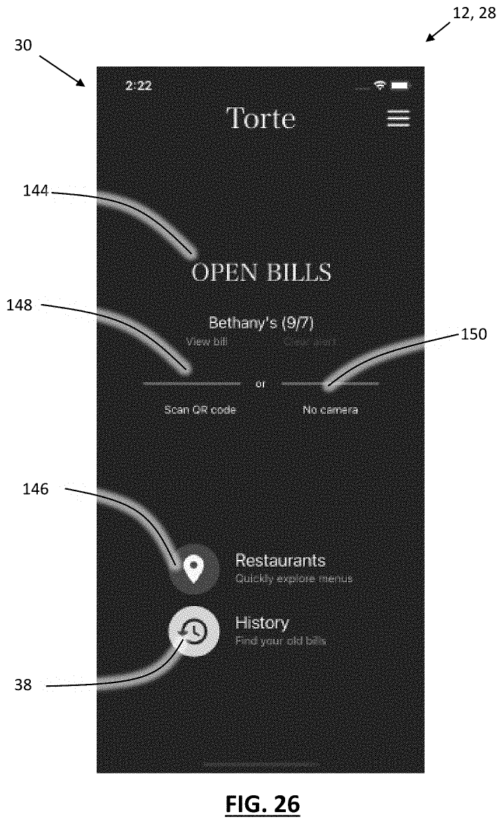

FIG. 26 shows an open bills inset 144 of main menu 30 of the user interface 28. As illustrated, the system 10 may illustrate the open bills inset 144 upon detection of the user having an open and/or unpaid bill. As such, the open bills inset 144 may beneficially allow a user to quick return to any open and/or unpaid bills from the main menu 30.

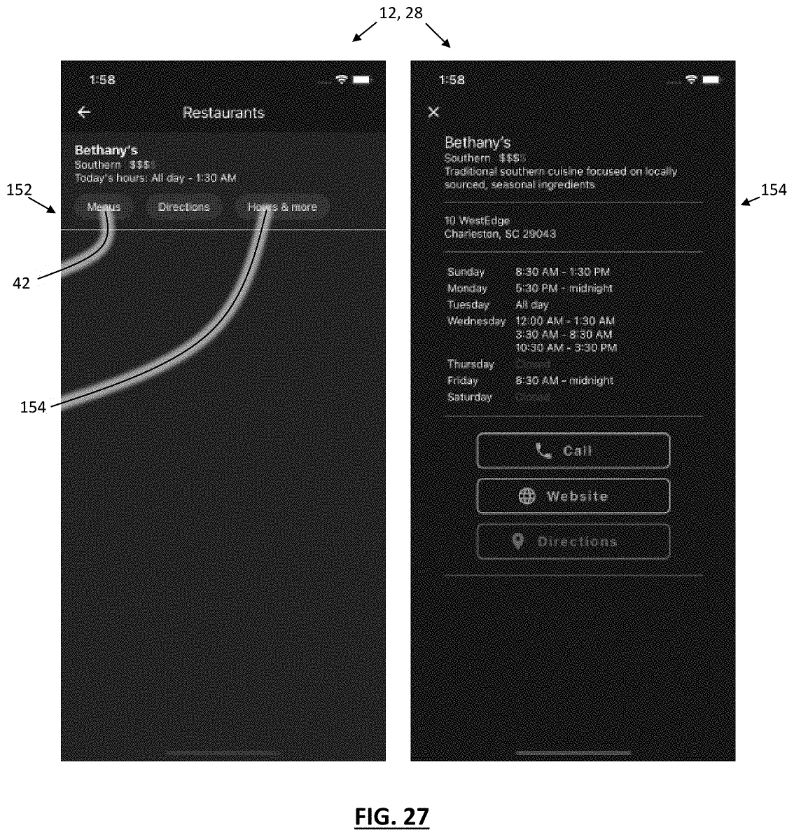

FIG. 27 is a restaurant information screen 152 for a restaurant within the user interface 28 for the system 10 on a mobile phone 12. As shown, the restaurant information screen 152 may provide basic information regarding the restaurant on an initial screen, as well as quick links to key areas. To get further information, a user may select the restaurant details screen 154 to view additional information, such as restaurant hours, website, address, phone number, social media, description, photos, rating, reviews, personal history with that restaurant, and more. Additionally, a user my access the ordering menu 42 from the restaurant information screen 152 to begin an order process. However, it is also envisioned that the order menu 42 may provide a viewable menu for the restaurant without initiating an ordering process. From the viewable menu, a user may select to start a bill, thereby taking you through the input menu as discussed with respect to FIG. 26 above.

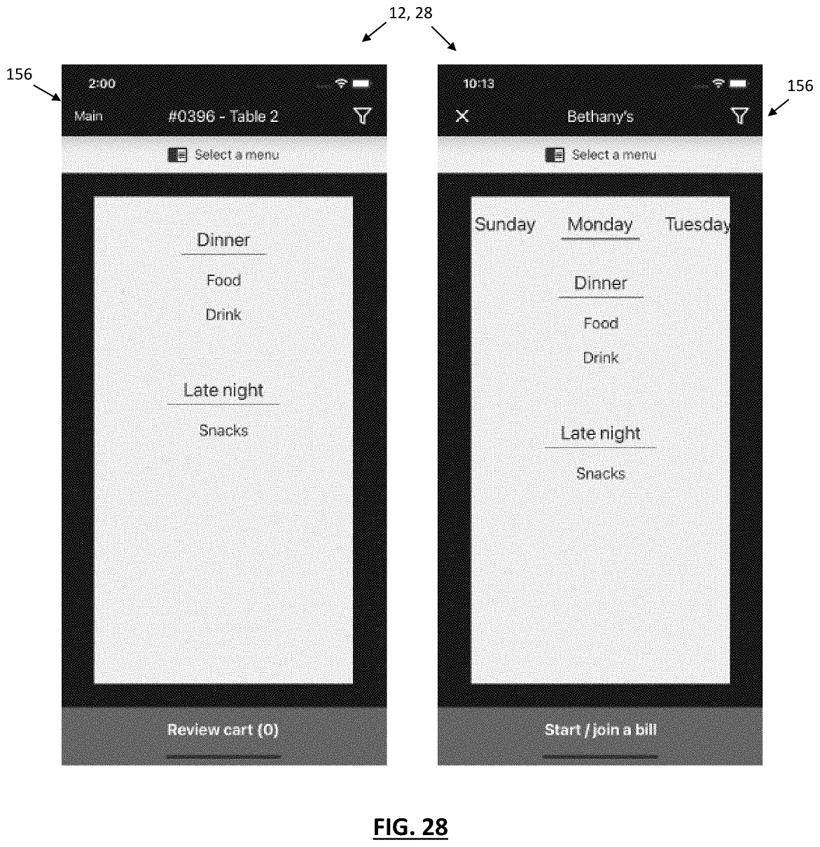

FIG. 28 is a meals screen 156 of the user interface 28 for the system 10 on a mobile phone 12. As shown, the meals screen 156 may beneficially provide a user the option to select a specific menu for a specific meal. For example, a user may select menus for breakfast, lunch, dinner, brunch, late night food, or a combination thereof. Similarly, the user may select menus for a specific day of the week. As a result, the system 10 beneficially provides restaurants the ability to customize menus for a time of day and a day of the week. Similarly, a user is then able to see which menus are available a specific time of day. As such, it is envisioned that the system 10 may also only allow selection of certain menus that match a given day and/or given time. It should also be noted that from the meals screen, a user may review an existing cart (e.g., FIG. 6, cart screen 46) for a bill or start and/or join a new or existing bill.

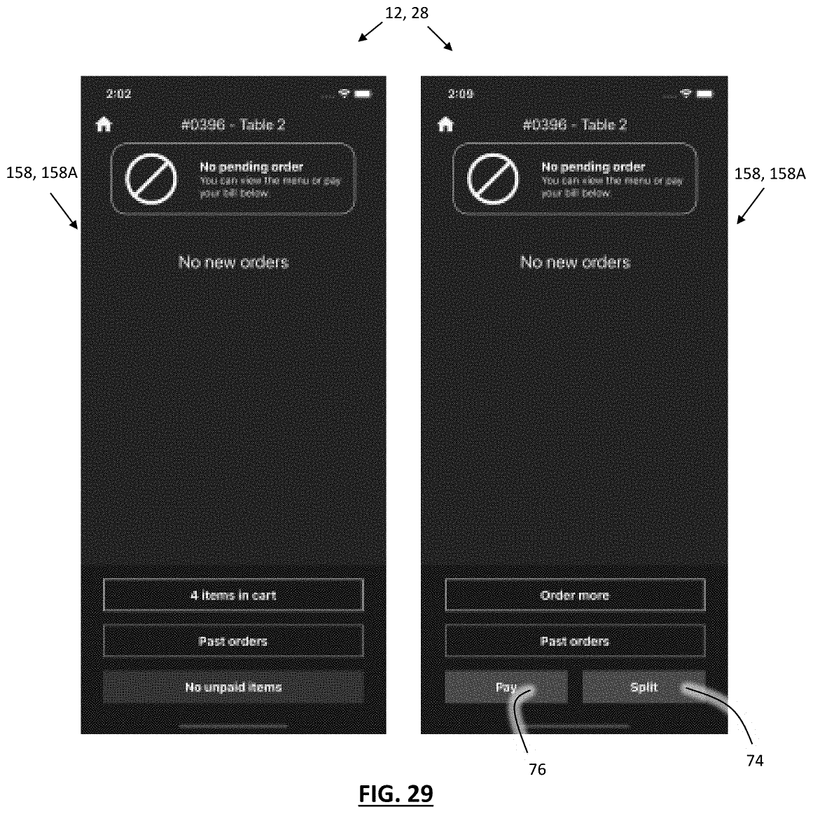

FIGS. 29-31 illustrates a status screen 158 of a user interface 28 for a mobile device 12. The status screen 158 may be enhanced with both context-dependent navigation for ordering and payment, as well as further options to interact with a pending order through the manage pending order process 166. The manage pending order process 166 may permit users to pause, request a “wait”, cancel, submit, or expedite (i.e., a user may still submit one or more items to bypass a collaborative order that has been paused) all or part of an order, or a combination thereof. The business interface may similarly have controls to influence a pause, wait, cancellation, or expedition of all or part of an order, with or without input from the user. Additionally, the process may be progressed automatically without input from the user or business. One or more users may also be granted special permissions, such as singular or overriding control over submission of the order(s), which may be beneficial in certain circumstances like pickup ordering.

FIG. 29 illustrates the status screen 158 without any pending orders 158A. The status screen 158 may show a user options to explore the menu, review the current bill, or initiate payment depending on the state of the restaurant, bill, and/or user. Payment could mean the entire bill 76, or a portion of the bill, such as through splitting 74, as described above. The status screen 158 may also show the status of each user, item, cart, order, and/or their relation to each other on the bill. For example, users may be grouped according to their cart progress so the entire group can better coordinate their orders, which may be visible throughout some or all variations of the status screen 158 depending on certain conditions such as if this is a single-user bill.

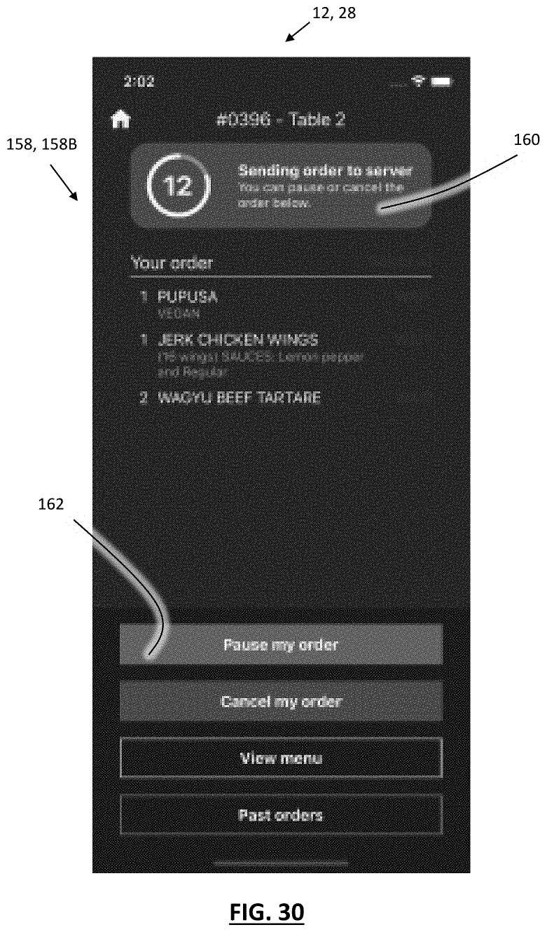

FIG. 30 illustrates the status screen 158 once an order has been submitted 158B. Once a cart has been finalized, an order may be joined or created created and information about that order may be displayed. The information may include visual cues, like a timer 160 or color-coding, as well as descriptive text. This information may be restricted to those with a finalized cart, or more commonly visible by any user on the bill.

The timer 160 displays countdown before a further action may be taken by the system. The timer may or may not start automatically based on certain factors such as whether other users are in the process of ordering or have yet to order. In one example of the status screen 158B, the system automatically begins countdown until the order (i.e., all finalized carts) is automatically submitted to the restaurant (e.g., the POS). Any desired duration of time may be programmed into the automatic timer 160 depending on the current need. The timer 160 may respond to a number of events and their sequence, such as users adjusting their carts or whether pause requests or wait requests are created, extended, or removed

Any user (i.e., one or more users) on the order that has submitted their cart (i.e., their items) may pause the order 162. This may advantageously afford users time to confer with others at the table, double-check the menu or their items, or wait for others. Similarly, a user who has not yet submitted their items for ordering may initiate a wait of the order to pause the timer 160, for instance to provide time to finalize their own carts. Additionally, it should be noted that users who have ordered may also have the option to cancel their order.

The timer 160 or order progress may further be controlled or influenced by the restaurant (e.g., the POS). For example, the POS may be responsible for the order submission. This has the advantage of ensuring the POS is online and accepting orders, rather than providing full control to the end users. The POS online status may also be communicated to the user (e.g., through the status screen 158). There may be additional information and options available to the user in case the restaurant fails to complete order submission.

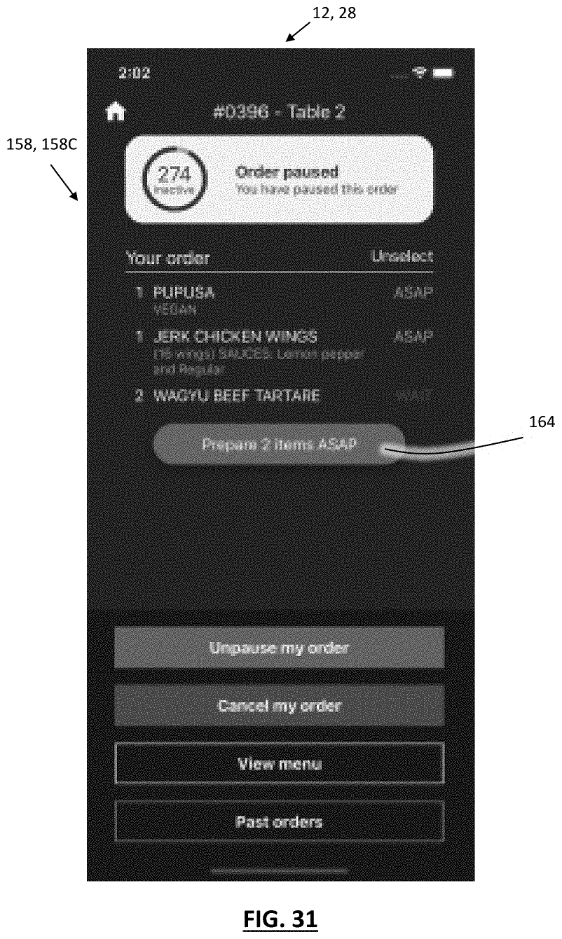

FIG. 31 illustrates the status screen 158 after the timer 160 has been paused or “waiting” has been initiated 158C. A color code or other description may indicate that waiting or pausing has been initiated.

Advantageously, users reviewing the status screen 158 may review all items from their order or other users on the order. A user may be able to select select one or more of items to order as soon as possible (ASAP), even if the order is paused or waiting for other users. Thus, the ordering process as described above may provide users various options for ordering as a group and/or individually.

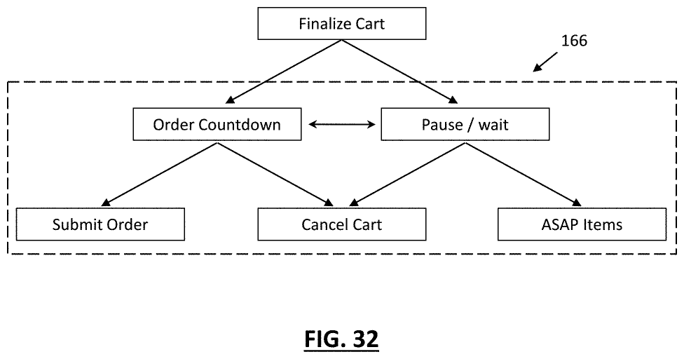

FIG. 32 illustrates a process flow of a manage pending order operation 166 of the system. Once a user has finalized one or more items within their cart, a user may be directed to a manage pending orders screen. Depending on the status of the bill, order, user, or combination thereof, an order countdown may automatically begin. Beneficially, the order countdown may be paused or otherwise interrupted (e.g., begin a wait period) by a user to offer more time to perform one or more additional actions prior to submission of the order, such as building the order, reviewing the order, or editing the order. The order countdown may then be manually resumed by user input, or such a wait period may include its own countdown whereby once the pause countdown has completed, the order countdown may again commence. Beneficially during a wait period, a user may select one or more specific items within the order to submit those items urgently, thereby bypassing the manage pending orders process. The manage pending orders process is exited when a user cancels or reverses the finalization of their cart, or the order is submitted to the restaurant for fulfillment (for instance, following the completion of the order countdown).

It should also be noted that the manage pending order may incorporate a plurality of collaborative users, as discussed herein. As such, a plurality of users may reach the manage pending orders screen so that pausing, urgently submitted items, additional actions, or a combination thereof may be completed by each of the plurality of users. That is, any single user may begin a countdown for order submission, yet any additional user may pause the countdown, may submit specific items urgently, or both. These privileges may be restricted based on the user, bill, order status, or a combination thereof.

It should be noted that the process described herein may include one or more additional steps or may remove one or more of the described steps based on a desired application. While the process has been described in detail pertaining to a restaurant or other food establishment, it is envisioned that the system may be utilized in any desired industry, thus providing a customizable and tunable system. While the process has been described in detail pertaining to orders placed on-site, it is envisioned that the system may be utilized to permit ordering for pickup, delivery, preparing orders in advance of arrival, or even submitting orders in advance of arrival. While the process has been described in detail pertaining to orders placed in association with a particular table, it is envisioned that the system may be utilized for ordering and paying for items when not associated with a table, for example fast food, quick-service restaurants, communal dining, cafes, bars, food halls, theaters, food courts, stadiums, and airports. While the process has been described in detail pertaining to mobile menus, mobile ordering, and mobile payment, it is envisioned that the system may allow other functionality such as WiFi connectivity, one or more additional application interactions, one or more additional features pertaining to the users, or a combination thereof. While the process has been described in detail pertaining to a “lightweight” POS, it is envisioned that the system may further features of a full-service POS, including ticket printing, kitchen display systems, analytics and guest tracking, marketing, accounting and payroll, inventory, and staffing. While the process has been described in detail pertaining to ordering users fulfilling payment, it is envisioned that the system may utilize outside accounts to pay for the orders, for examples as a gift or birthday present to one of more users at the meal or from a corporate account which may be connected to a present user's device or supplied by a company before, during, or after the meal. While the process has been described in detail pertaining to payment by credit card, it is envisioned that the system may utilize peer-to-peer transactions, mobile wallets, blockchain, in-app currency, other payment methods, or a combination thereof. While the process has been described in detail pertaining to users paying for items ordered via their interaction with a user interface, it is envisioned that the system may be utilized to permit a server to enter orders on behalf the user while still allowing the user to pay via the application. While the process has been described in detail pertaining to pay via the application, it is envisioned that the system may be utilized to permit one or more users to pay outside the application. It is not intended that the processes or user interfaces described herein limit variations that may be possible.

### ELEMENT LIST

10 System

12 Mobile Phone

14 Tablet

16 Computer

18 Cellular Network

20 Local Network

22 Point-of-Sale (POS)

24 Table

26 Ordered Item

28 User Interface

29 Business Interface

30 Main Menu

32 Order and Pay Process

34 Join Friends Process

36 Scan Bill Process

38 History Screen

40 Loyalty Screen

42 Catalog Menu

44 Selectable Items

46 Cart Screen

46A Combined Preview

46B By Ticket Preview

48 Filter Menu

50 Filter Parameters

52 Waiting Room Screen

54 Item Detail Screen

56 Selectable Options

58 Send Order

58A Send Individual Order

58B Send All Orders

60 Bill Review Screen

62 Indicator

64 Bill Number

66 Bill Split Bar

68 Split by Item Screen

70 Split by Ticket Screen

72 Ticket

74 Bill Split Screen

75 Item Split Screen

76 Pay Screen

78 Warning Window

80 Scan Review Screen

82 Scanned Item

84 Status Column

86 User Selection

90 Main Menu

92 Bill Column

94 Status Window

96 Recent Bills Screen

98 Recent Orders Screen

100 Table Number

110 Bill Screen

112 Selectable Action

114 Close Table

116 Outstanding Orders Screen

118 Enter into POS

120 Manager Portal

122 Performance Metrics

124 Bill Breakdown

130 System Process

132 Order Process

134 Pay Process

136 Initiation/Association Process

138 Finalize Order Process

140 Order Entry Process

142 Scan/Calculation Process

144 Open Bills Inset

146 Explore Restaurant Menus Screen

148 Scan QR Code Screen

150 Manual Entry Screen

152 Restaurant Information Screen

154 Restaurant Details Screen

156 Meals Screen

158 Status Screen

158A Status Screen Prior to Order Creation

158B Status Screen After Order Creation

158C Status Screen After Pausing

160 Timer

162 Pause Order

164 Send Order ASAP

166 Manage Pending Orders Process

The explanations and illustrations presented herein are intended to acquaint others skilled in the art with the invention, its principles, and its practical application. The above description is intended to be illustrative and not restrictive. Those skilled in the art may adapt and apply the invention in its numerous forms, as may be best suited to the requirements of a particular use.

Accordingly, the specific embodiments of the present invention as set forth are not intended as being exhaustive or limiting of the teachings. The scope of the teachings should, therefore, be determined not with reference to this description, but should instead be determined with reference to the appended claims, along with the full scope of equivalents to which such claims are entitled. The omission in the following claims of any aspect of subject matter that is disclosed herein is not a disclaimer of such subject matter, nor should it be regarded that the inventors did not consider such subject matter to be part of the disclosed inventive subject matter.

Plural elements or steps can be provided by a single integrated element or step. Alternatively, a single element or step might be divided into separate plural elements or steps.

The disclosure of “a” or “one” to describe an element or step is not intended to foreclose additional elements or steps.

While the terms first, second, third, etc., may be used herein to describe various elements, components, regions, layers and/or sections, these elements, components, regions, layers and/or sections should not be limited by these terms. These terms may be used to distinguish one element, component, region, layer or section from another region, layer, or section. Terms such as “first,” “second,” and other numerical terms when used herein do not imply a sequence or order unless clearly indicated by the context. Thus, a first element, component, region, layer, or section discussed below could be termed a second element, component, region, layer, or section without departing from the teachings.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

Unless otherwise stated, a teaching with the term “about” or “approximately” in combination with a numerical amount encompasses a teaching of the recited amount, as well as approximations of that recited amount. By way of example, a teaching of “about 100” encompasses a teaching of 100+/−15.

The disclosures of all articles and references, including patent applications and publications, are incorporated by reference for all purposes. Other combinations are also possible as will be gleaned from the following claims, which are also hereby incorporated by reference into this written description.

What is claimed is:

1: A collaborative ordering and payment method comprising:
generating a bill number;
ordering one or more items associated with the bill number, wherein the one or more items are ordered by a plurality of users;
dividing the ordered items among the plurality of users and calculating an amount owed by each user; and
processing payment by one or more of the users to fulfill a total amount owed.

2: The collaborative ordering and payment method of claim 1, wherein the ordering of the one or more items by the plurality of users is completed via a user interface.

3: The collaborative ordering and payment method of claim 2, wherein one or a plurality of the users orders a portion of the one or more items on multiple separate devices.

4: The collaborative ordering and payment method of claim 1, wherein the user is logged into their account within an application for the collaborative ordering and payment method.

5: The collaborative ordering and payment method of claim 1, wherein each of the plurality of users is required to enter payment information prior to ordering the one or more items.

6: The collaborative ordering and payment method of claim 1, wherein the dividing of the ordered items is completed by each user selecting one or more of the ordered items.

7: The collaborative ordering and payment method of claim 6, wherein each of the ordered items is split into any desired number of portions, and each portion is selected by any of the plurality of users.

8: The collaborative ordering and payment method of claim 7, wherein the transmission of the ordered items to the operator is done in a compiled manner with multiple items being transmitted together.

9: The collaborative ordering and payment method of claim 1, wherein the transmission of the ordered items to the operator is done by each user transmitting their ordered items individually.

10: The collaborative ordering and payment method of claim 1, wherein the plurality of users are shown details pertaining to a collaborative order; and
wherein the plurality of users modify, coordinate, or both their ordered items based on the details.

11: The collaborative ordering and payment method of claim 1, wherein the operator closes the bill number after the total amount owed is paid by the plurality of users or the bill number is closed automatically.

12: The collaborative ordering and payment method of claim 1, wherein a balance of the total amount owed is tracked, and a warning is generated to indicate to each user if the balance is still due before or after processing of the user's payment.

13: The collaborative ordering and payment method of claim 1, wherein the operator marks the bill as unpaid if the total amount owed is not paid in full, and at least one of the plurality of users is charged the total amount owed along with a fee.

14: The collaborative ordering and payment method of claim 1, wherein the one or more items are food items selectable in a user interface of a mobile device.

15: The collaborative ordering and payment method of claim 1, wherein the plurality of users complete steps (a) through (d) via a user interface on a mobile device, and an operator receives substantially real-time updates from the plurality of users via a user interface on a tablet in communication with the mobile device.

16: The collaborative ordering and payment method of claim 15, wherein the mobile device is a plurality of mobile devices collaboratively transmitting data to the tablet.

17: The collaborative ordering and payment method of claim 1, wherein the dividing of the ordered items is completed by dividing the ordered items amongst the plurality of users by who ordered each individual item.

18: The collaborative ordering and payment method of claim 1, wherein the bill number is associated with a table or establishment identifier; and
wherein a plurality of bill numbers are associated with a single table or establishment identifier, and the plurality of bill numbers are also tracked individually.

19: The collaborative ordering and payment method of claim 1, wherein prior to step (c), the ordered items are transmitted to an operator to enter the ordered items into a point of sale (POS).

20: The collaborative ordering and payment method of claim 1, wherein one or more of steps (b) through (d) are completed a plurality of times by one or more of the plurality of users.
